(19) United States
(12) Patent Application Publication
(10) Pub. No.: US 2016/0148235 A1
(43) Pub. Date: May 26, 2016

(54) PRICE DECISION DEVICE, PRICE DECISION SYSTEM, AND PRICE DECISION METHOD

(71) Applicant: Seiko Epson Corporation, Tokyo (JP)

(72) Inventor: Hironori Hasei, Azumino-shi (JP)

(21) Appl. No.: 14/862,825

(22) Filed: Sep. 23, 2015

(30) Foreign Application Priority Data
Nov. 20, 2014 (JP) 2014-235812

(51) Int. Cl. G06Q 30/02

(52) U.S. Cl. CPC G06Q 30/0206

(57) ABSTRACT

A price decision device includes: a user information acquisition unit which acquires user information about a user; a desired product acquisition unit which acquires desired product information about a desired product of the user; a price decision unit which decides a suggested price that is a price of the desired product suggested to the user according to a state of the user based on the acquired user information; and an output unit (information transmission unit) which outputs the decided suggested price.

This application claims priority to Japanese Patent Application No. 2014-235812, filed Nov. 20, 2014, the entirety of which is hereby incorporated by reference.

### BACKGROUND

1. Technical Field

The present invention relates to a price decision device, a price decision system, and a price decision method.

2. Related Art

According to the related art, an information device for health management which carries out statistical processing using the biometric information and living information of a user and displays the health condition of the user in everyday life or displays advice to improve the everyday life of the user is known (see, for example, JP-A-10-055398).

The information device for health management disclosed in JP-A-10-055398 is used by a person who is trying to restrain the progress of disease, a person who is trying to prevent disease, and a person who goes on weight control, or the like. This information device for health management has a detection unit which measures each of the pulse waveform, pulse rate value, blood pressure level, and blood sugar level of the user. The information device for health management also displays a menu screen where living information made up of the three items of meal information, exercise information, and rest information is inputted, and the information device for health management acquires the living information. The information device for health management then executes selected statistical processing on the measured biometric information and the acquired living information and displays advice for living support based on the result of the statistical processing.

By using such an information device for health management, the user can be provided with effective advice suitable for the user's purpose.

By the way, at the start of use of a health management device or a health management system such as the information device for health management disclosed in JP-A-10-055398, users are strongly motivated to achieve their own purposes by utilizing the device and system. However, as a few months pass since the start of use, an increasing number of users tend to become less motivated and stop using the health management device and the health management system effectively, for example, stop referring to suggested advice or the like.

Therefore, a configuration to allow users to experience the advantages of utilizing the health management device and the health management system so as to encourage continued use thereof is desired.

### SUMMARY

An advantage of some aspects of the invention is to provide a price decision device, a price decision system, and a price decision method that can encourage the user to continue using the health management device and the health management system.

A price decision device according to a first aspect of the invention includes: a user information acquisition unit which acquires user information about a user; a desired product acquisition unit which acquires desired product information about a desired product of the user; a price decision unit which decides a suggested price that is a price of the desired product suggested to the user according to a state of the user based on the user information that is acquired; and an output unit which outputs the suggested price that is decided.

According to the first aspect, a suggested price of a desired product of the user (product which the user wishes to purchase) is decided according to the state of the user based on the user information, and the suggested prices is outputted. Thus, if the desired product is a product which improves the state of the user (including a product which maintains the state), the suggested price of the desired product can be lowered, whereas if the desired product is a product which deteriorates the state of the user, the suggested price of the desired price can be raised. This makes it easier to purchase the product which improves the state of the user, and harder to purchase the product which deteriorates the state. Therefore, the good state of the user can be maintained.

If such a price decision device is employed in a health management device and a health management system, it can allow the user to experience the financial advantage of purchasing the product which improves the state of the user. Therefore, the user can be encouraged to continue using the health management device and the health management system.

In the first aspect, it is preferable that the device includes a storage unit which stores a retail price of a product and price change information of each of the product corresponding to the state of the user, and that the price decision unit decides the suggested price of the desired product on the basis of a retail price of the desired product and the price change information of the desired product corresponding to the state of the user that is acquired.

The price change information may be, for example, a rate of price change, a discount rate, and a surcharge rate by which the retail price of the product is multiplied, and also an amount of discount and an amount of surcharge of each product.

According to the first aspect with this configuration, the price decision unit decides the suggested price of the desired product on the basis of the retail price of the desired product and the price change information of the desired product, acquired respectively from the storage unit. This enables quick and proper decision of the suggested price of the desired product corresponding to the state of the user. Moreover, since the rate of price change can be specifically set for each state of the user, the suggested price corresponding to the current state of the user can be properly outputted, even with the same desired product.

In the first aspect, it is preferable that the user information includes purpose information indicating a purpose set by the user, and that the price change information varies according to the purpose information.

Here, with the same desired product, there may be cases where the product improves the state of the user and where the product deteriorates the state of the user. For example, vitamin K is said to have an insulin sensitivity promoting effect, and therefore food products containing this vitamin K are considered to be potentially able to improve the states of diabetic patients. However, since vitamin K may prevent the effect of anticoagulants, food products containing this vitamin K are considered to be potentially capable of deteriorating the states of patients taking anticoagulants for the treatment of cerebral infarction.

In contrast, in the first aspect with the configuration described above, since the price change information varies according to the purpose information indicating the purpose set by the user (for example, improvement in diabetic symptoms or rehabilitation from cerebral infarction), the suggested price of the desired product can be decided according to the state and purpose of the user. Therefore, the suggested price of the desired product can be decided properly.

In the first aspect, it is preferable that the state of the user is acquired on the basis of information acquired according to the purpose information, of a plurality of pieces of information included in the user information.

Here, the user information to be referred to in determining the state of the user varies depending on the purpose set by the user. For example, if the purpose is improvement in athletic capability, it is conceivable to determine the state of the user, referring to the exercise intensity and the duration of the exercise carried out by the user. However, if the purpose is dieting, it is conceivable to determine the state of the user, referring to calorie intake and calories burned.

Therefore, in the first aspect with the configuration described above, the state of the user is determined on the basis of information acquired according to the purpose set by the user, of a plurality of pieces of information included in the user information. Thus, the state of the user can be determined on proper information. Accordingly, not only the state of the user can be properly determined, but also the processing load on the price decision device can be reduced compared with the case where the state of the user is determined on the basis of all the information included in the user information.

In the first aspect, it is preferable that the user information includes each of biometric information, activity information, and meal information of the user, and that the state of the user is acquired on the basis of the biometric information, the activity information, and the meal information included in the user information, if the purpose is maintenance of health.

The maintenance of health includes, for example, dieting.

According to the first aspect with the configuration described above, if the purpose is maintenance of health, the state of the user is determined on the basis of the biometric information, the activity information, and the meal information of the user. Thus, the state of the user can be properly determined according to the purpose.

For example, calorie intake can be calculated on the basis of the meal information, and calories burned can be calculated on the basis of the biometric information and the activity information. If the calorie intake is above the calories burned and the desired product is a high-calorie food product, the suggested price of the desired product can be raised above the retail price, thus restraining further increase in calorie intake. This can achieve reduction in obesity.

In the first aspect, it is preferable that the user information includes each of biometric information and physical motion information of the user, and that the state of the user is acquired on the basis of each of the biometric information and the physical motion information if the purpose is improvement in athletic capability.

According to the first aspect with this configuration, if the purpose set by the user is improvement in athletic capability, the state of the user is determined on the basis of the biometric information and the physical motion information of the user. This enables execution of analysis of the state of the user corresponding to the purpose.

For example, if pulse waves are acquired as the biometric information, and change in acceleration due to physical motion of the user is acquired as the physical motion information, the exercise intensity (for example, exercise intensity based on the Karvonen formula) at the time of exercise of the user and the duration of exercise are found. The degree of exercise carried out by the user can be grasped on the basis of the exercise intensity and the duration of exercise. Therefore, for example, if the user carries out an exercise with relatively high intensity for a relatively long time, the suggested price of a product which contributes to improvement in athletic capability (for example, feed products such as meat and health appliances) can be lowered, thus encouraging purchase of products suitable for the user's purpose, and encouraging further exercise. Thus, the use of the health management device or the health management system can be promoted further.

In the first aspect, it is preferable that the biometric information of the user includes information based on pulse waves of the user.

The other biometric information than the information based on pulse waves may be blood pressure, blood sugar level, body temperature, and the amount of perspiration or the like.

Here, as the information based on pulse waves, pulse waveform and pulse rate or the like may be employed as an example. Based on the pulse rate and other information, the exercise intensity of the exercise carried out by the user, and the calories burned by the user or the like can be estimated. Thus, as the biometric information of the user includes the information based on the pulse waves of the user, various states of the user can be grasped.

A price decision system according to a second aspect of the invention includes: an information processing device used by a user; and the price decision device described above. The information processing device has a display unit which displays the suggested price outputted from the price decision device.

The information processing device can be, for example, a terminal device used by the user or a terminal device installed in a store or the like.

According to the second aspect, similar effects to the price decision device can be achieved. Moreover, since the information processing device displays the suggested price transmitted and outputted from the price decision device, the suggested price of the desired product can be securely suggested to the user.

In the second aspect, it is preferable that the information processing device includes a processing device-side user information acquisition unit which acquires the user information, and an information transmission unit which transmits the user information to the price decision device, that the user information includes position information indicating a current position of the user, that the price decision device includes a price-changing product acquisition unit which acquires price-changing product information about a price-changing product that is a product with the suggested price changing according to the state of the user, of products handled by a store near the current position of the user, on the basis of the position information, and a price-changing product information transmission unit which transmits the price-changing product information that is acquired, to the information processing device, and that the display unit displays the price-changing product information received from the price decision device.

The store includes an unmanned store such as a vending machine as well as a manned stored where products are sold. The store near the current position of the user can be, for example, the store nearest to the current position of the user or a store within a predetermined range around the current position.

According to the second aspect with this configuration, the price decision device transmits, to the information processing device, price-changing product information which is the product information of a price-changing product, of products handled by the store near the current position of the user indicated by the received position information. The information processing device causes the display unit to display the price-changing product information. This enables the user to grasp the price-changing product handled at the store near the current position. Therefore, the user can grasp the price-changing product before visiting the store or before deciding to purchase the product at the store.

In the second aspect, it is preferable that the price-changing product acquisition unit decides a suggested price of the price-changing product according to the state of the user, that the price-changing product information transmission unit transmits the suggested price of the price-changing product to the information processing device, and that the display unit displays the price-changing product information and the suggested price of the price-changing product, each received from the price decision device.

According to the second aspect with this configuration, the information processing device displays the product information of a price-changing product (price-changing product information) and also the suggested price of the price-changing product. Therefore, the user can grasp the suggested price (sales price) of the price-changing product before visiting the store or before deciding to purchase the product at the store. Thus, consumer appetite for the product which improves the state of the user can be increased.

In the second aspect, it is preferable that the system includes a detection device which detects biometric information and physical motion information of the user included in the user information and which transmits the detected information to the information processing device.

According to the second aspect with this configuration, the detection device detects biometric information and physical motion information of the user and transmits the biometric information and the physical motion information to the information processing device. This enables determination on the state of the user using the biometric information and the physical motion information of the user that are actually detected. Therefore, the reliability of the determination on the state of the user can be improved and the time and effort of inputting the information can be saved, compared with the case where the user inputs the user's own biometric information and physical motion information. Moreover, if the detection device is configured to transmit the detected biometric information and physical motion information to the information processing device successively, the information processing device and hence the price decision device can determine the state of the user in real time.

A price decision method according to a third aspect of the invention is a price decision method carried out by a price decision device which decides a price of a product. The method includes: acquiring user information about a user; acquiring desired product information about a desired product of the user; deciding a suggested price which is a price of the desired product suggested to the user, according to a state of the user based on the user information that is acquired; and outputting the suggested price that is decided.

According to the third aspect, as the price decision device executes the price decision method, similar effects to the price decision device according to the first aspect can be achieved.

### BRIEF DESCRIPTION OF THE DRAWINGS

The invention will be described with reference to the accompanying drawings, wherein like numbers reference like elements.

FIG. 1 is a schematic view showing the configuration of a health management system according an embodiment of the invention.

FIG. 2 is a block diagram showing the configuration of a detection device in the embodiment.

FIG. 3 is a block diagram showing the configuration of a control unit of the detection device in the embodiment.

FIG. 4 is a block diagram showing the configuration of an information processing device in the embodiment.

FIG. 5 is a block diagram showing the configuration of a control unit of the information processing device in the embodiment.

FIG. 6 shows an example of a user information registration screen in the embodiment.

FIG. 7 shows an example of a meal information registration screen in the embodiment.

FIG. 8 is a block diagram showing the configuration of a store terminal in the embodiment.

FIG. 9 is a block diagram showing the configuration of a control unit of the store terminal in the embodiment.

FIG. 10 is a block diagram showing the configuration of a vending machine in the embodiment.

FIG. 11 is a block diagram showing the configuration of a control unit of the vending machine in the embodiment.

FIG. 12 is a block diagram showing the configuration of a web server in the embodiment.

FIG. 13 is a block diagram showing the configuration of a control unit of the web server in the embodiment.

FIG. 14 is a block diagram showing the configuration of a management server in the embodiment.

FIG. 15 is a block diagram showing the configuration of a control unit of the management server in the embodiment.

FIG. 16 is a flowchart showing price decision processing in the embodiment.

FIG. 17 shows an example of a suggestion screen in the embodiment.

FIG. 18 is a flowchart showing price-changing product transmission processing in the embodiment.

FIG. 19 shows an example of a price-changing product display screen in the embodiment.

### DESCRIPTION OF EXEMPLARY EMBODIMENTS

Hereinafter, an embodiment of the invention will be described with reference to the drawings.

### Schematic Configuration of Health Management System

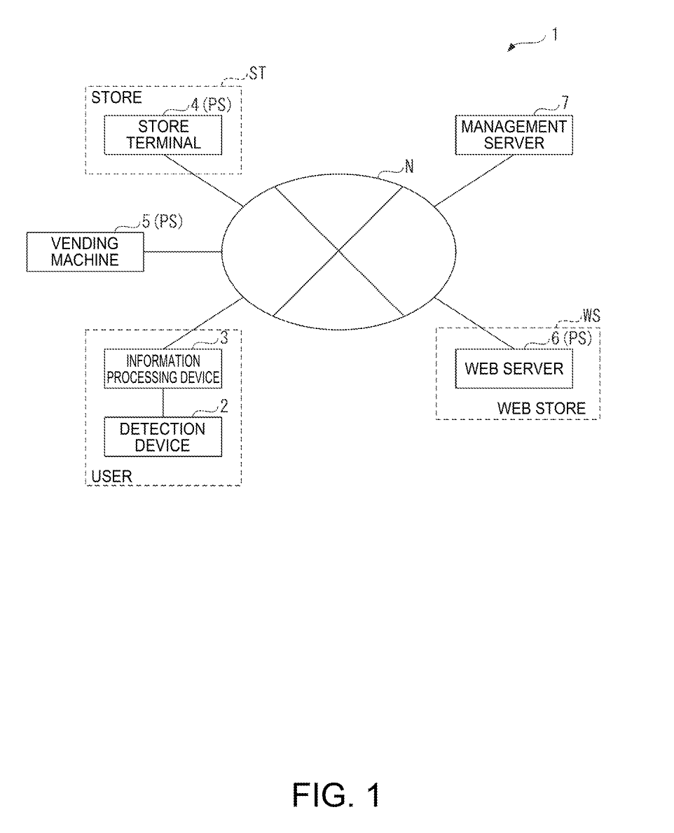

FIG. 1 is a schematic view showing the configuration of a health management system 1 according to this embodiment.

The health management system 1 according to the embodiment includes a detection device 2 and an information processing device 3 each being used by a user, a store terminal 4 used at a store ST, a vending machine 5, a web server 6 forming a web store WS, and a management server 7, as shown in FIG. 1. Of these, the information processing device 3, the store terminal 4, the vending machine 5, the web server 6 and the management server 7 are configured to be able to communicate with each other via a network N.

In this health management system 1, the management server 7 receives and stores user information about a user from the information processing device 3. Also, when the user decides to purchase a product (desired product) at the store ST, the vending machine 5 or the web store WS, the management server 7 adjusts the price of the desired product according to the state of the user based on the user information, transmits a suggested price which is the price after the adjustment, to the store terminal 4, the vending machine 5 or the web server 6, and thus causes the suggested price to be suggested to the user. In such a health management system 1, for example, the price of a product which improves the state of the user is lowered and the price of a product which deteriorates the state of the user is raised. If the user takes action to improve the user's own state, the prices of products are lowered, whereas if the user takes action to deteriorate the state, the prices of products are raised. Thus, the user is allowed to experience the financial advantage of practicing health management using the health management system 1, and is encouraged to continue using the health management system 1.

The configuration of each part of the health management system 1 will be described below.

In the description below, the store terminal 4, the vending machine 5 and the web server 6 may be collectively referred to as a product selling device PS, as shown in FIG. 1.

### Configuration of Detection Device

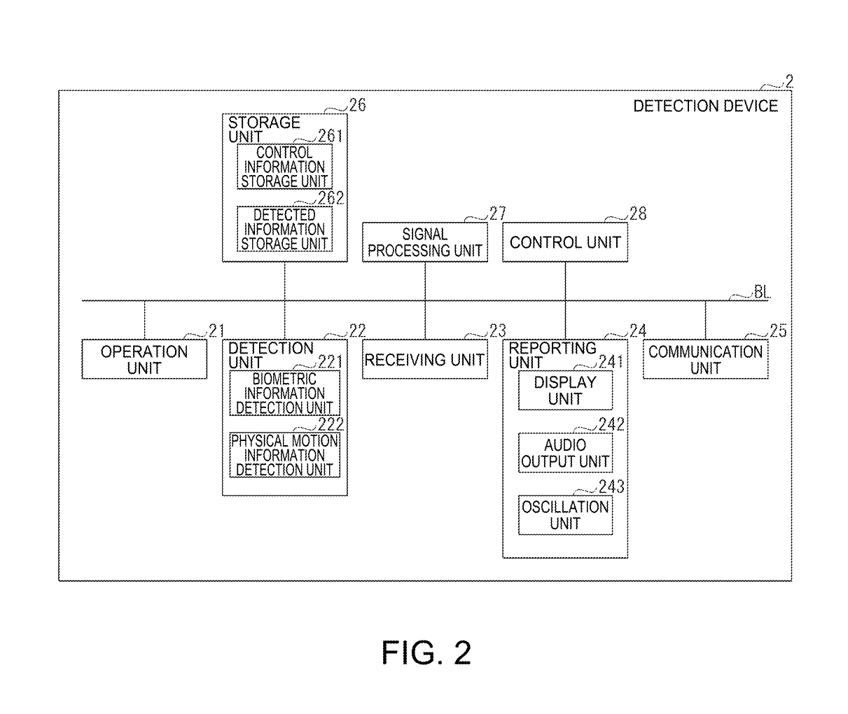

FIG. 2 is a block diagram showing the configuration of the detection device 2.

The detection device 2 is configured as a wearable device worn by the user. The detection device 2 detects and acquires biometric information, physical motion information and position information of the user and transmits these pieces of information to the information processing device 3. The detection device 2 has an operation unit 21, a detection unit 22, a receiving unit 23, a reporting unit 24, a communication unit 25, a storage unit 26, a signal processing unit 27, and a control unit 28, as shown in FIG. 2. These units are connected to each other via a bus line BL.

### Configuration of Operation Unit

The operation unit 21 has a plurality of buttons arranged on an exterior case of the detection device 2 and outputs an operation signal corresponding to a button that is entered (pressed), to the control unit 28. The operation unit 21 is not limited to the configuration having buttons and may be a touch panel arranged on a display unit 241, described below, or may be configured to detect a tap operation by the user.

### Configuration of Detection Unit

The detection unit 22 has a biometric information detection unit 221 and a physical motion information detection unit 222.

The biometric information detection unit 221 detects biometric information of the user and outputs the biometric information to the control unit 28, under the control of the control unit 28. The biometric information detection unit 221 detects biometric information such as pulse waves, blood pressure, blood sugar level, body temperature, and the amount of perspiration.

The physical motion information detection unit 222 detects physical motion information indicating the physical motion of the user and outputs the physical motion information to the control unit 28, under the control of the control unit 28. In the embodiment, the physical motion information detection unit 222 detects an acceleration signal changing with the physical motion of the user, as physical motion information. The physical motion information detection unit 222 may detect angular velocity changing with the physical motion of the user, instead of or in addition to acceleration. Such physical motion information is classified as activity information of the user information, described below.

### Configuration of Receiving Unit

The receiving unit 23 acquires position information indicating the current position of the detection device 2 (position information indicating the current position of the user). The receiving unit 23 can be configured to correspond to a satellite positioning system, for example, the GPS (Global Positioning System), and acquire the position information based on radio waves received from satellites. The receiving unit 23 can also be configured to calculate the position information using wireless radio waves for communication. The position information acquired by the receiving unit 23 is included in environment information of the user information, described below.

### Configuration of Reporting Unit

The reporting unit 24 reports various kinds of information to the user, under the control of the control unit 28. The reporting unit 24 has a display unit 241, an audio output unit 242, and an oscillation unit 243.

The display unit 241 has a display measure including a display panel of various kinds such as liquid crystal and a plurality of LEDs (light emitting diodes) and displays information inputted from the control unit 28. For example, the display unit 241 displays the biometric information and the physical motion information detected by the detection unit 22. The display unit 241 also causes the plurality of LEDs to function as an indicator and switches on or off at least one LED, thus displaying the exercise intensity calculated on the basis of the biometric information and the physical motion information.

The audio output unit 242 is formed with an audio output measure such as a speaker and outputs an audio corresponding to audio information inputted from the control unit 28.

The oscillation unit 243 has a motor whose operation is controlled by the control unit 28, and for example, reports a warning to the user in the form of oscillation generated by the driving of the motor.

### Configuration of Communication Unit

The communication unit 25 has a communication module capable of communicating with the information processing device 3. The communication unit 25 periodically transmits the detected biometric information and physical motion information and the acquired position information to the information processing device 3. In the embodiment, the communication unit 25 wirelessly communicates with the information processing device 3, using a near field communication method. However, the communication unit 25 may communicate with the information processing device 3 via a relay device such as a cradle, or may be communicate with the information processing device 3 via a cable. Moreover, the communication unit 25 may communicate with an external device such as the information processing device 3 via the network N.

### Configuration of Storage Unit

The storage unit 26 is formed by a storage measure having a flash memory or the like and has a control information storage unit 261 and a detected information storage unit 262.

The control information storage unit 261 stores control information such as various programs and data that are necessary for the operation of the detection device 2.

The detected information storage unit 262 stores the biometric information and the physical motion information detected by the detection unit 22, the position information acquired by the receiving unit 23, and the result of analysis of the biometric information and the physical motion information by the control unit 28 (for example, pulse rate). The detected information storage unit 262 is configured to store these types of information in order, and overwrite the information that is stored at the earliest time with the newly acquired information when the storage capacity runs short.

### Configuration of Signal Processing Unit

The signal processing unit 27 has a signal processing circuit such as a DSP (digital signal processor) and executes signal processing of the biometric information and the physical motion information detected by the detection unit 22.

For example, the signal processing unit 27 eliminates a physical motion noise component based on an acceleration signal detected by the physical motion information detection unit 222 from a pulse wave signal detected by the biometric information detection unit 221 and thus obtains a pulsation signal. The signal processing unit 27 then carries out frequency analysis such as FFT (fast Fourier transform) on the pulsation signal and outputs the result of processing (power spectrum) thus obtained, to the control unit 28. Based on the frequency specified as the pulse in the result of processing, the pulse rate per unit time is counted.

### Configuration of Control Unit

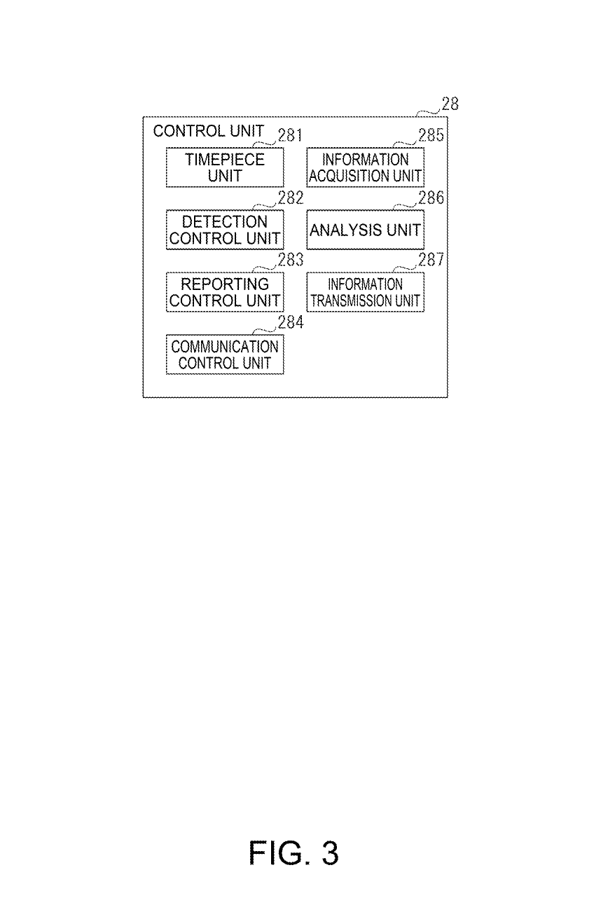

FIG. 3 is a block diagram showing the configuration of the control unit 28.

The control unit 28 has a processing circuit such as a CPU (central processing unit) and controls the operation of the detection device 2 autonomously or in response to an operation signal inputted from the operation unit 21. The control unit 28 has a timepiece unit 281, a detection control unit 282, a reporting control unit 283, a communication control unit 284, an information acquisition unit 285, an analysis unit 286, and an information transmission unit 287, as shown in FIG. 3, as a functional unit realized by the processing circuit executing a program stored in the control information storage unit 261.

The timepiece unit 281 measures the current date and time.

The detection control unit 282 controls the operation of the detection unit 22. For example, if the detection control unit 282 determines that the detection device 2 is not worn by the user, the detection control unit 282 stops the detection of biometric information by the biometric information detection unit 221 and thus reduces power consumption.

The reporting control unit 283 controls the operation of the reporting unit 24. For example, the reporting control unit 283 outputs reporting information including a display and audio expressing the operating state of the detection device 2 and the result of detection by the detection unit 22, to the reporting unit 24, and causes the reporting unit 24 to report the reporting information. The reporting control unit 283 also drives the motor of the oscillation unit 243 according to need and thus causes predetermined information to be reported in the form of oscillation generated by the driving of the motor.

The communication control unit 284 controls the operation of the communication unit 25.

The information acquisition unit 285 acquires various signals and information inputted from the operation unit 21, the detection unit 22, the receiving unit 23, the communication unit 25 and the signal processing unit 27. For example, the information acquisition unit 285 causes the biometric information and the physical motion information inputted from the detection unit 22, the position information inputted from the receiving unit 23, and the processing result of the frequency analysis inputted from the signal processing unit 27, to be stored in the storage unit 26 (detected information storage unit 262).

The analysis unit 286 analyzes the results of detected inputted from the biometric information detection unit 221 and the physical motion information detection unit 222 and analyzes the biometric information and the physical motion information. For example, the analysis unit 286 calculates the pulse rate on the basis of the processing result of the frequency analysis inputted from the signal processing unit 27. The analysis unit 286 also quantifies the blood pressure, blood sugar level, body temperature and the amount of perspiration or the like, on the basis of the signal inputted from the biometric information detection unit 221. The analysis unit 286 then causes the analyzed biometric information and physical motion information to be stored in the storage unit 26 (detected information storage unit 262).

The information transmission unit 287 successively transmits the information detected by the detection unit 22, the result of the analysis by the analysis unit 286, and the position information acquired by the receiving unit 23, to the information processing device 3, if the communication with the information processing device 3 via the communication unit 25 is available. Thus, the biometric information and the physical motion information (each including a signal) and the position information of the user, detected and analyzed by the detection device 2, are acquired by the information processing device 3 and successively transmitted from the information processing device 3 to the management server 7.

The information transmission unit 287 may be configured to transmit the information stored in the detected information storage unit 262 to the information processing device 3 when an operation signal corresponding to an input operation to transmit the stored information is inputted from the operation unit 21 or when operation information to transmit this information from the information processing device 3 via the communication unit 25 is received.

Hereinafter, the biometric information, the physical motion information and the position information may be collectively referred to as detected information.

### Configuration of Information Processing Device

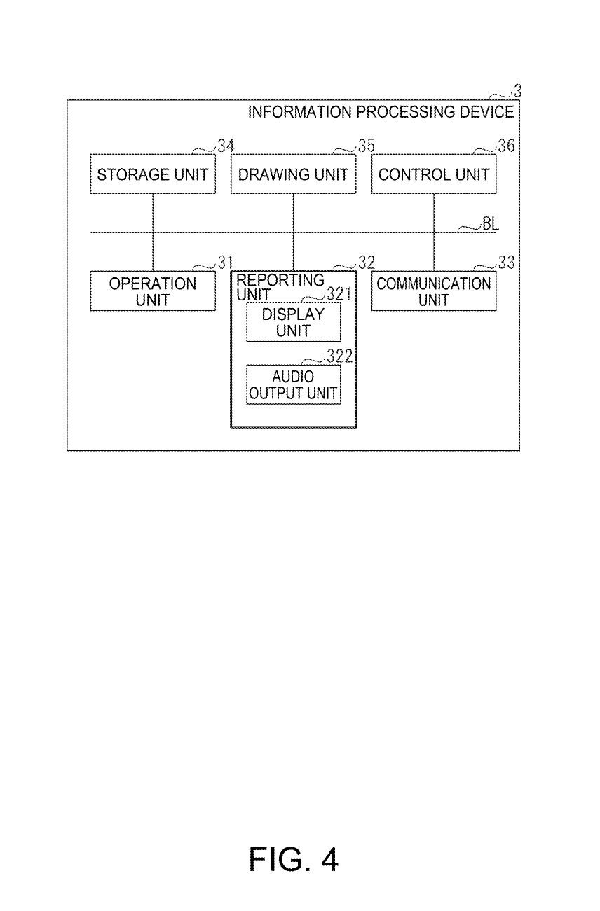

FIG. 4 is a block diagram showing the configuration of the information processing device 3.

The information processing device 3 is an information processing device according to the invention and is formed by a mobile information terminal such as a smartphone (multifunctional mobile phone) or tablet and laptop PC (personal computer) that is portable by the user. The information processing device 3 communicates with the detection device 2, acquires the detected information from the detection device 2, and transmits the user information including the detected information to the management server 7, described below. The information processing device 3 also has a web browsing function and is configured to be able to access the web server 6 forming the web store WS and browse through web pages of the web store WS.

The information processing device 3 has an operation unit 31, a reporting unit 32, a communication unit 33, a storage unit 34, a drawing unit 35, and a control unit 36, as shown in FIG. 4.

### Configuration of Operation Unit

The operation unit 31 accepts an input operation by the user and outputs an operation signal corresponding to the input operation, to the control unit 36, similarly to the operation unit 21. The operation unit 31 can be formed, for example, by physical keys or a touch panel provided on the casing of the information processing device 3, and can also be formed by a keyboard and a pointing device or the like wire-connected or wirelessly connected to the information processing device 3.

### Configuration of Reporting Unit

The reporting unit 32 reports various kinds of information to the user, under the control of the control unit 36. The reporting unit 32 has a display unit 321 and an audio output unit 322.

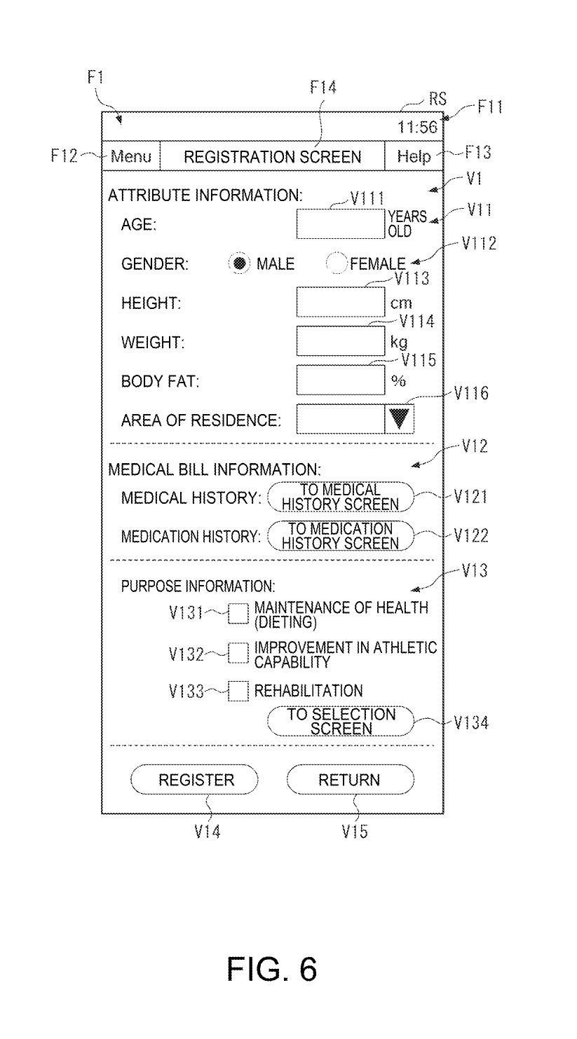

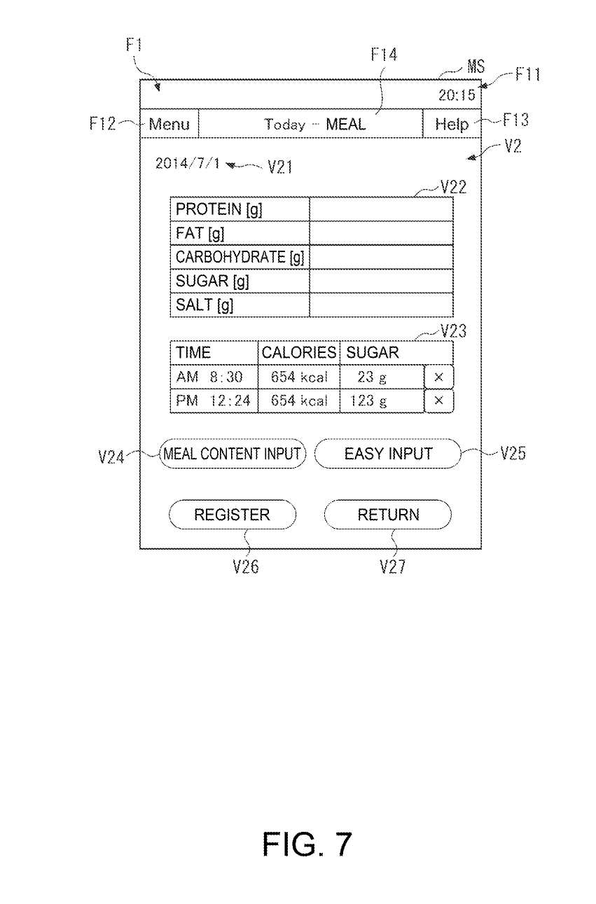

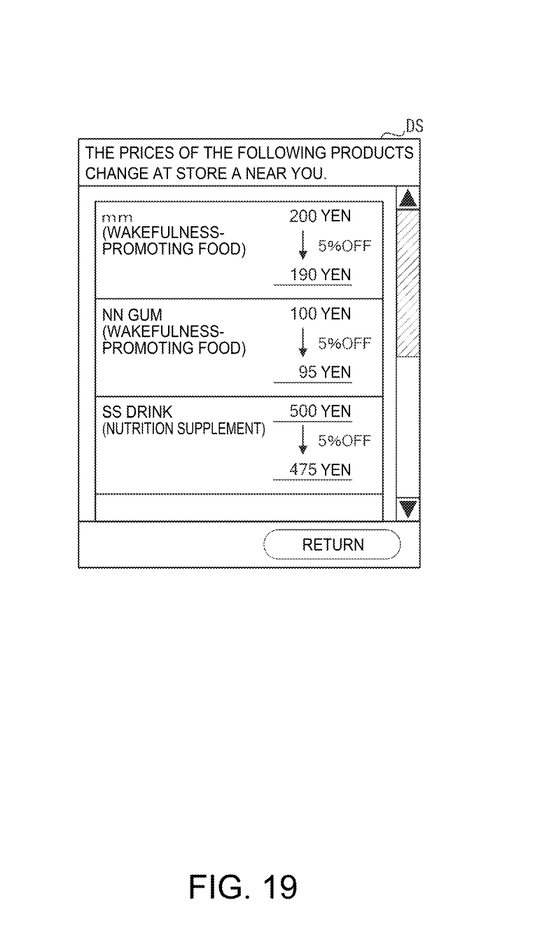

The display unit 321 has a display panel of various kinds such as liquid crystal and displays an image drawn by the drawing unit 35, described below. For example, such an image can be a web page acquired from the web server 6, or a user information registration screen RS (see FIG. 6), a meal information registration screen MS (see FIG. 7) and a price-changing product display screen DS (see FIG. 19), described below.

The audio output unit 322 is formed with an audio output measure such as a speaker and outputs an audio corresponding to audio information inputted from the control unit 36.

### Configuration of Communication Unit

The communication unit 33 has a first communication module capable of communicating with an external device such as the detection device 2, and a second communication module capable of communicating with an external device (web server 6 and management server 7 or the like) on the network N, and communicates with each external device under the control of the control unit 36. If each external device and the communication unit 33 can communicate with each other by the same communication method, the communication unit 33 only has to have one of the first communication module and the second communication module.

### Configuration of Storage Unit

The storage unit 34 stores various programs and data that are necessary for the operation of the information processing device 3. As such programs, the storage unit 34 stores, for example, an OS (operating system), a web browser, and a health management application. The health management application is, for example, an application which executes processing to analyze the state of the user on the basis of the biometric information and the physical motion information detected by the detection device 2 and thus acquired, and then present advice to improve the health condition, to the user. As the data, the storage unit 34 stores, for example, connection information (for example, IP address) to connect to the management server 7, and the user ID assigned to the user.

The storage unit 34 also stores the detected information received by the communication unit 33 from the detection device 2, under the control of the control unit 36.

### Configuration of Drawing Unit

The drawing unit 35 draws image information of an image to be displayed on the display unit 321, under the control of the control unit 36. For example, the drawing unit 35 draws an image of a screen shown at the time of executing the OS or various applications executed by the control unit 36, and also draws an image of a web page acquired from the web server 6. The drawing unit 35 then outputs an image signal corresponding to the image drawn, to the display unit 321, and causes the display unit 321 to display the image.

### Configuration of Control Unit

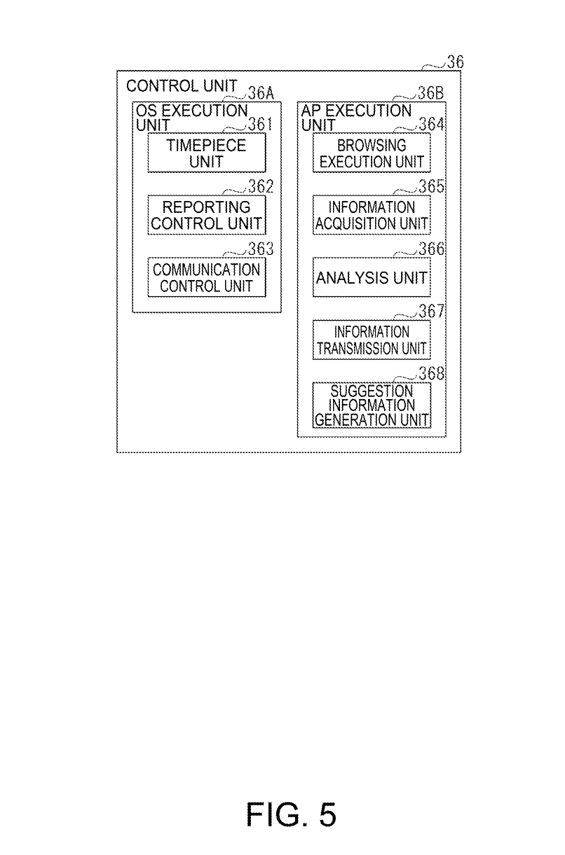

FIG. 5 is a block diagram showing the configuration of the control unit 36.

The control unit 36 is formed with a CPU (central processing unit) and executes the programs stored in the storage unit 34, thus controlling the operation of the information processing device 3. The control unit 36 has an OS execution unit 36A and an AP execution unit 36B.

### Configuration of OS Execution Unit

The OS execution unit 36A is a functional unit which executes the OS stored in the storage unit 34 and has a timepiece unit 361, a reporting control unit 362, and a communication control unit 363.

The timepiece unit 361 measures the current time.

The reporting control unit 362 controls the drawing unit 35 and causes the drawing unit 35 to draw an image of a screen shown at the time of executing the OS or application and causes the display unit 321 to display the image. The reporting control unit 362 also outputs an audio signal of an audio outputted at the time of executing the OS or application, to the audio output unit 322.

The communication control unit 363 controls the communication unit 33 to communicate with the detection device 2, the web server 6 and the management server 7.

### Configuration of AP Execution Unit

The AP execution unit 36B executes an application designated by the OS execution unit 36A in response to an operation signal inputted from the operation unit 31, of the applications stored in the storage unit 34. The AP execution unit 36B has a browsing execution unit 364 which functions as the web browser stored in the storage unit 34 is executed, and an information acquisition unit 365, an analysis unit 366, an information transmission unit 367 and a suggestion information generation unit 368 which function as the health management program is executed.

The browsing execution unit 364 accesses a web server (for example, web server 6) indicated by an IP address inputted or selected by the user, via the communication unit 33, then downloads a web page from the web server, causes the drawing unit 35 to draw an image of the web page, and causes the display unit 321 to display the image. In this case, the browsing execution unit 364 transmits information inputted by the user on the web page, to the web server from which the web page is acquired, and transmits and receives information to and from the web server.

Such a web page can be a web page of the web store WS. The information transmitted from the browsing execution unit 364 can be the user ID or information about a product which the user wishes to purchase (desired product).

The information acquisition unit 365 is equivalent to the processing device-side user information acquisition unit according to the invention. The information acquisition unit 365 acquires the detected information received from the detection device 2 via the communication unit 33 and also acquires information inputted on the user information registration screen RS (see FIG. 6) and the meal information registration screen MS (see FIG. 7), each of which is one of the screens shown at the time of executing the health management application. The information acquisition unit 365 also acquires the suggestion information or the like received from the management server 7 via the communication unit 33. The information acquisition unit 365 causes the storage unit 34 to store the various kinds of information that is acquired.

### User Information Registration Screen

FIG. 6 shows an example of the user information registration screen RS.

Here, the user information registration screen RS drawn by the drawing unit 35 and displayed on the display unit 321 under the control of the reporting control unit 362 will be described.

The user information registration screen RS is one of the screens shown at the time of executing the health management application, as described above, and is a screen which allows the user to input a part of the user information, which is information about the user. In the user information registration screen RS, a fixed display area F1 is set in the upper part of the screen and a variable display area V1 is set in the lower part of the screen, as shown in FIG. 6.

At the top of the fixed display area F1, a time display are F11 where the current date and time measured by the timepiece unit 361 is set is arranged. On the left-hand side at the bottom of the fixed display area F1, a button F12 to shift to a menu screen (not shown) when pressed is arranged. On the right-hand side, a button F13 to shift to a help screen (not shown) when pressed is arranged. In the area between these buttons F12 and F13, a title F14 indicating the content of the screen is arranged.

In the variable display area V1, an attribute information setting area V11, a medical bill information setting area V12, and a purpose information setting area V13 are set in order from the top side of the screen toward the bottom side, and a registration button V14 and a return button V15 are set as well.

The attribute information setting area V11 is an area for setting attribute information which is information about the profile of the user. In this attribute information setting area V11, an age input section V111, a gender selection section V112, a height input section V113, a weight input section V114, a body fat percentage input section V115, and an area of residence selection section V116 are arranged.

The medical bill information setting area V12 is an area for setting medical bill information which is information about the medical history and medication history of the user. In this medical bill information setting area V12, buttons V121, V122 to shift to screens (not shown) for inputting the medical history and the medication history, respectively, are arranged. The medical history and the medication history inputted on these screens are temporarily stored in the storage unit 34, and are registered as medical bill information when the registration button V14, described below, is entered.

The purpose information setting area V13 is an area for setting purpose information indicating the purpose of the user using the health management application which is linked with the detection device 2 and the management server 7. In this purpose information setting area V13, selection sections V131 to V133 which enable selection of “maintenance of health (dieting)”, “improvement in athletic capability”, and “rehabilitation” (rehabilitation when and after one is ill) are arranged, and a button V134 to shift to a selection screen (not shown) for selecting types of rehabilitation is arranged as well. Such types of rehabilitation can be, for example, rehabilitation from diabetes, cerebral infarction, and bone fracture, or the like.

Then, if the registration button V14 is entered, the information acquisition unit 365 acquires the attribute information, the medical bill information and the purpose information inputted in the respective setting areas V11 to V13 and causes the storage unit 34 to store (register) these pieces of information.

Meanwhile, if the return button V15 is entered, the content temporarily stored in the storage unit 34 is destroyed and the screen display shifts to the screen displayed before the user information registration screen RS is displayed.

### Meal Information Registration Screen

FIG. 7 shows an example of the meal information registration screen MS.

Next, the meal information registration screen MS displayed on the display unit 321 similarly to the user information registration screen RS will be described.

The meal information registration screen MS is one of the screens shown at the time of executing the health management application, as described above, and is a screen displayed on the display unit 321 as a predetermined operation is executed at the time of executing the health management application. Also, the meal information registration screen MS is a screen for inputting meal information which is a part of the user information and which shows the content of daily meals of the user.

In the meal information registration screen MS, the fixed display area F1 is set in the upper part of the screen and a variable display area V2 is set in the lower part of the screen, as shown in FIG. 7.

In the variable display area V2, a date display section V21 showing the date of the day in question, a display section V22 where the contents of the meals of the day in question are displayed, a display section V23 where summaries of the meals of the day in question are displayed, a detailed setting button V24, a simplified setting button V25, a registration button V26, and a return button V27 are arranged.

Of these, in the display section V22, the intakes of protein (P), fat (F), carbohydrate (C), sugar and salt of the day in question are set.

In the display section V23, the start time of each meal of the day in question, and the calorie intake and the amount of sugar in the meals are set.

The detailed setting button V24 is a button to shift to a selection screen (not shown) where the menu of a meal taken by the user, the amount of the meal, and the start time of the meal can be selected. As the user selects and inputs items according to the content of the meal on this selection screen, the content of the meal is analyzed, and the intakes of protein, fat, carbohydrate, sugar and salt in the meal and the total calories of the meal are calculated. The results of the calculation and the start time of the meal are temporarily stored in the storage unit 34 and reflected in the display sections V22, V23.

The analysis of the meal content may be carried out, referring to an external database (database held in an external device), or may be executed via an external server (external device).

The simplified setting button V25 is a button to shift to an input screen (not shown) for inputting the start time of the meal, the type of meal and the amount of meal. As the user selects and inputs the start time of the meal, the type of meal (“meal”, “drinking alcohol”, and “snack” or the like) and an approximate amount of meal on this input screen, an approximate calorie intake in the meal is calculated on the basis of a preset calculation formula. The result of the calculation and the start time of the meal are temporarily stored in the storage unit 34 and reflected in the display sections V22, V23, as in the case of the selection and input on the selection screen.

Then, if the registration button V26 is entered, the information acquisition unit 365 causes the storage unit 34 to store (register) anew the meal information indicating the meal content temporarily stored in the storage unit 34.

Meanwhile, if the return button V27 is entered, the content temporarily stored in the storage unit 34 is destroyed and the screen display shifts to the screen displayed before the meal information registration screen MS is displayed. Therefore, the contents in the display sections V22, V23 return to the original contents.

Back to FIG. 5, the analysis unit 366 analyzes the biometric information and the physical motion information acquired by the information acquisition unit 365. For example, the analysis unit 366 calculates the calories burned per day by the user, the exercise intensity at the time of exercise, and the duration of exercise, on the basis of the acquired biometric information and physical motion information.

The information transmission unit 367 transmits the user information together with the user ID to the management server 7. This user information includes biometric information, activity information, attribute information, medical bill information, purpose information, and environment information.

The biometric information includes the pulse waves, the pulse rate, the blood pressure, the blood sugar level, the body temperature and the amount of perspiration acquired from the detection device 2.

The activity information includes the acceleration which is the physical motion information acquired from the detection device 2 and also includes the calories burned per day by the user, the exercise intensity, the duration of exercise, and the meal information analyzed by the analysis unit 366.

The attribute information, the medical bill information and the purpose information include the attribute information, the medical bill information and the purpose information inputted on the user information registration screen RS.

The environment information includes the position information acquired from the detection device 2. As will be described in detail below, the weather, atmospheric temperature and humidity at the current position of the user indicated by the position information, and WBGT (web bulb globe temperature) calculated or acquired on the basis of these, area added to the environment information by the management server 7.

The suggestion information generation unit 368 generates suggestion information to be suggested to the user by the reporting unit 32. Such suggestion information can be, for example, advice to improve the state of the user analyzed on the basis of the biometric information and the physical motion information, or the like.

### Configuration of Store Terminal

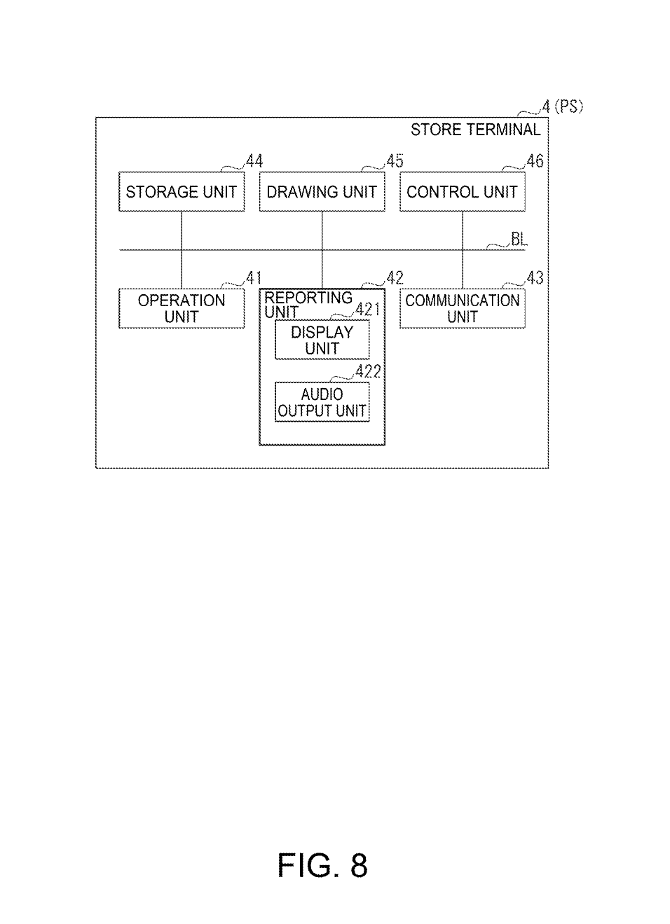

FIG. 8 is a block diagram showing the configuration of the store terminal 4.

Back to FIG. 1, the store terminal 4 is an information processing device according to the invention. The store terminal 4 is a terminal device such as a POS (point of sale) register used at the store ST, as described above, and is used for inventory control of products handled at the store ST.

The store terminal 4 has an operation unit 41, a reporting unit 42, a communication unit 43, a storage unit 44, a drawing unit 45, and a control unit 46, as shown in FIG. 8.

The operation unit 41 is formed by a keyboard and a pointing device and outputs an operation signal corresponding to an input operation by the user (manager or sales clerk) of the store terminal 4, to the control unit 46. Also, the operation unit 41 has an acquisition measure (for example, a barcode reader) which is arranged in the POS register and acquires authentication information of an intending buyer (for example, the user ID or the card number owned by the intending buyer), and product information (product ID) of a product which the intending buyer intends to purchase. The operation unit 41 thus outputs the authentication information and the product information acquired by the acquisition measure, to the control unit 46.

The reporting unit 42 has a display unit 421 having a display of various kinds for displaying an image drawn by the drawing unit 45, and an audio output unit 422 having an audio output measure such as a speaker for outputting an audio corresponding to an audio signal inputted from the control unit 46.

The communication unit 43 communicates with the management server 7 via the network N, under the control of the control unit 46.

The storage unit 44 stores various programs and data that are necessary for the operation of the store terminal 4. As such programs, the storage unit 44 stores, for example, an OS executed by the control unit 46 and an inventory control application to control the inventory of products handled at the store ST. Also, the storage unit 44 stores a price acquisition program to communicate with the management server 7 and acquire suggestion information including the suggested price of the desired product decided at the management server 7 when the intending buyer decides to purchase the product.

Moreover, as the data, for example, the storage unit 44 stores identification information (store ID) unique to the store ST where the store terminal 4 is installed. The storage unit 44 also stores a database to control the number of items in stock, of the products handled. In this database, the product ID (for example, JAN code) of each product handled at the store ST and the number of items in stock of the product are set in association with each other. In this database, the product name, the explanation of the product and the retail price or the like may be included.

The drawing unit 45 draws an image to be displayed on the display unit 421 and causes the display unit 421 to display image information of the image. For example, the drawing unit 45 draws a screen shown at the time of executing the OS, a screen shown at the time of executing the inventory control application, and a screen including the acquired suggestion information.

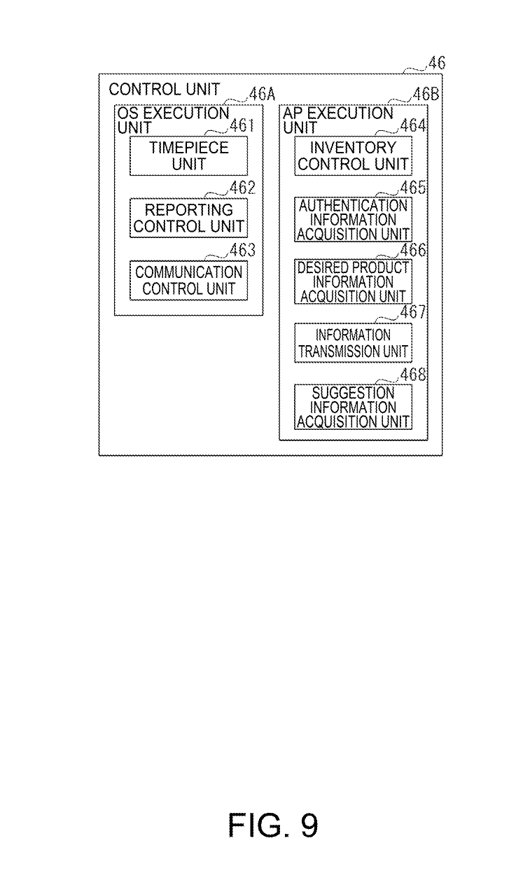

FIG. 9 is a block diagram showing the configuration of the control unit 46 of the store terminal 4.

The control unit 46 is formed with a processing circuit such as a CPU and executes the programs stored in the storage unit 44, thus controlling the operation of the store terminal 4. The control unit 46 includes an OS execution unit 46A and AP execution unit 46B.

The OS execution unit 46A is a functional unit which executes the OS stored in the storage unit 44, and has a timepiece unit 461, a reporting control unit 462, and a communication control unit 463, similarly to the OS execution unit 36A. These functional units 461 to 463 execute similar processing to the timepiece unit 361, the reporting control unit 362, and the communication control unit 363.

The AP execution unit 46B executes an application designated by the OS execution unit 46A in response to an operation signal inputted from the operation unit 41, of the applications stored in the storage unit 44. The AP execution unit 46B has an inventory control unit 464 which functions as the inventory control program stored in the storage unit 44 is executed, and an authentication information acquisition unit 465, a desired product information acquisition unit 466, an information transmission unit 467, and a suggestion information acquisition unit 468 which function as the price acquisition program is executed.

The inventory control unit 464 controls the number of items in stock of the products handled at the store ST. Specifically, the inventory control unit 464 sets the product ID of a product handled, inputted by the manager of the store ST using the operation unit 41, and the number of items in stock of the product handled, in the database stored in the storage unit 44.

Also, the inventory control unit 464 periodically communicates with the management server 7 via the communication control unit 463 and the communication unit 43 and transmits the content of the database to the management server 7. Thus, the management server 7 can grasp of items in stock of the products handled at the store ST.

The AP execution unit 46B executes the price acquisition program when the intending buyer decides to purchase a product. For example, the AP execution unit 46B executes the price acquisition program when the desired product of the intending buyer, of the products handled at the store ST, is carried to the register. Thus, the authentication information acquisition unit 465, the desired product information acquisition unit 466, the information transmission unit 467, and the suggestion information acquisition unit 468 function.

The authentication information acquisition unit 465 acquires the authentication information of the intending buyer acquired by the acquisition measure. This authentication information may be the user ID, as described above, or may be any other information which is authentication information stored in association with the user ID in the database held in the management server 7, described below, such as the store ST membership number, point card number, and credit card number.

The desired product information acquisition unit 466 acquires the product information (product ID) of the desired product acquired by the acquisition measure.

The information transmission unit 467 transmits the authentication information of the intending buyer and the product information of the desired product thus acquired, to the management server 7. The information transmission unit 467 does not execute the transmission of the information if no authentication information is acquired.

The suggestion information acquisition unit 468 acquires the suggestion information including the suggested price of the desired product received from the management server 7 after the transmission of the information is carried out by the information transmission unit 467. The suggestion information is displayed on the display unit 421 by the reporting control unit 462. Thus, the intending buyer can grasp the suggested price of the desired product.

### Configuration of Vending Machine

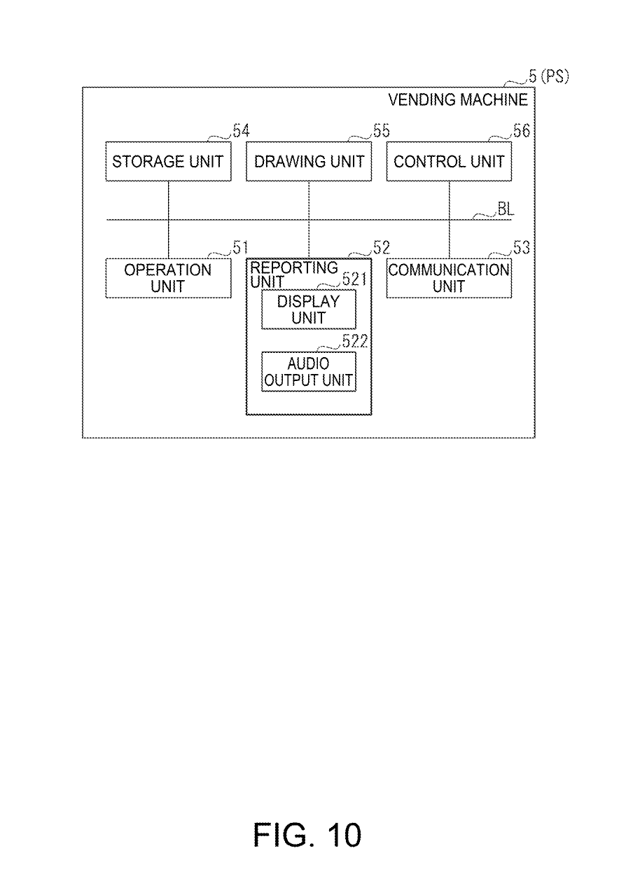

FIG. 10 is a block diagram showing the configuration of the vending machine 5.

The vending machine 5 is an information processing device according to the invention. The vending machine 5 is configured to sell a product corresponding to an input operation by the intending buyer, and similarly to the store terminal 4, transmits the number of items in stock of the product handled, to the management server 7. Also, when the authentication information of the intending buyer is acquired, similarly to the store terminal 4, the vending machine 5 according to the embodiment transmits the product information of the desired product together with the authentication information of the intending buyer to the management server 7, acquires the suggestion information, and presents the suggestion information to the intending buyer.

The vending machine 5 has a similar configuration to the store terminal 4. Specifically, the vending machine 5 has an operation unit 51, a reporting unit 52, a communication unit 53, a storage unit 54, a drawing unit 55, and a control unit 56, as shown in FIG. 10.

The operation unit 51 is formed with purchase buttons for the products handled by the vending machine 5. The operation unit 51 outputs an operation signal corresponding to a purchase button that is entered, to the control unit 56. The operation unit 51 also has an acquisition measure for acquiring the authentication information of the intending buyer, and outputs the acquired authentication information to the control unit 56. Such an acquisition measure may be a device which reads the authentication information recorded on a card owned by the intending buyer, or may be a button that can be entered by the intending buyer (physical key and software key.

The reporting unit 52 has a display unit 521 which displays an image drawn by the drawing unit 55, and an audio output unit 522 which outputs an audio corresponding to an audio signal inputted from the control unit 56. Of these, the image displayed on the display unit 521 may be the suggestion information (suggestion information including the suggested price of the desired product selected by the intending buyer) received from the management server 7. The display unit 521 may further display an image including the product name and explanation of the product handled.

The communication unit 53 communicates with the management server 7 under the control of the control unit 56. For example, the communication unit 53 transmits the number of items in stock of the products handled by the vending machine to the management server 7. Also, for example, the communication unit 53 transmits the authentication information of the intending buyer and the product ID of the desired product thus acquired, to the management server 7, and receives the suggestion information.

The storage unit 54 stores the identification information unique to the vending machine 5 and also stores a database (table) for controlling the number of items in stock of the products handled, similarly to the storage unit 44 of the store terminal 4. This database has substantially the same content as the database stored in the storage unit 44 of the store terminal 4.

The drawing unit 55 draws an image to be displayed on the display unit 521 and outputs image information of the image to the display unit 521, under the control of the control unit 56.

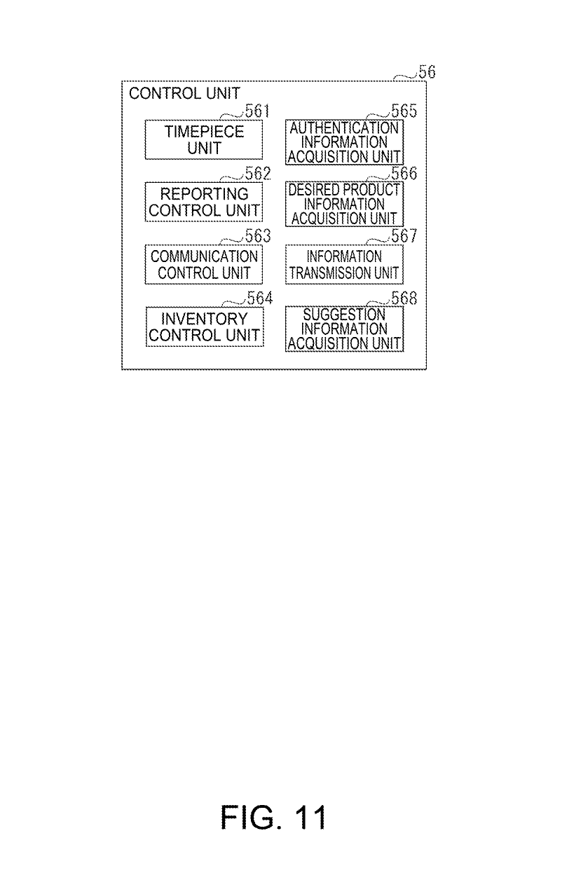

FIG. 11 is a block diagram showing the configuration of the control unit 56.

The control unit 56 is formed with a processing circuit such as a CPU and controls the operation of the vending machine 5. As shown in FIG. 11, the control unit 56 has a timepiece unit 561, a reporting control unit 562, a communication control unit 563, an inventory control unit 564 an authentication information acquisition unit 565, a desired product information acquisition unit 566, an information transmission unit 567, and a suggestion information acquisition unit 568, similarly to the control unit 46.

These functional units 561 to 568 function similarly to the functional units 461 to 468 of the store terminal 4.

For example, the authentication information acquisition unit 565 acquires the authentication information of the intending buyer acquired by the operation unit 51.

The desired product information acquisition unit 566 acquires the product information (product ID) of the desired product on the basis of an operation signal inputted from the operation unit 51.

The information transmission unit 567 transmits the authentication information of the intending buyer and the product information of the desired product thus acquired respectively, to the management server 7 via the communication control unit 563 and the communication unit 53.

The suggestion information acquisition unit 568 acquires the suggestion information from the management server 7 after the transmission of the information is carried out by the information transmission unit 567. As the suggestion information is displayed on the display unit 521, the intending buyer can grasp the suggested price of the desired product.

### Configuration of Web Server

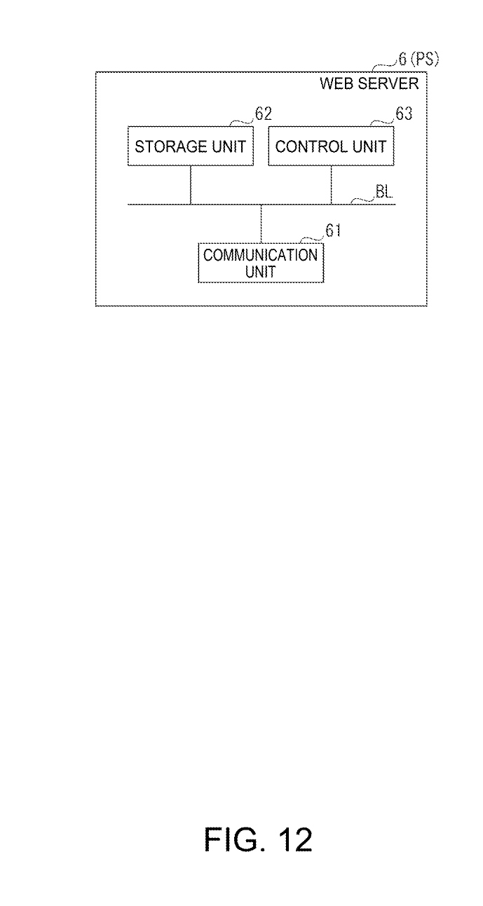

FIG. 12 is a block diagram showing the configuration of the web server 6.

The web server 6 forms the web store WS, as described above. The web server 6 is configured to be able to communicate with a device situated on the network N, such as the information processing device 3 and the management server 7. The web server 6 generates a web page of the web store WD in response to a request from the device and transmits the web page to the information processing device 3. Also, the web server 6 transmits the number of items in stock of the products handled, to the management server 7. Moreover, when the intending buyer carries out a product purchase operation, the web server 6 acquires the suggestion information from the management server 7.

The web server 6 has a communication unit 61, a storage unit 62, and a control unit 63, and these units are connected to each other via a bus line BL, as shown in FIG. 12. In addition to these units, the web server 6 may have an operation unit such as a keyboard and a pointing device, and a display unit which displays an operation screen, or the like.

The communication unit 61, under the control of the control unit 63, transmits and receives information to and from the device communicating with the web server 6.

The storage unit 62 stores an OS and various applications (including an inventory control program, a page generation program and a price acquisition program) which are necessary for the operation of the web server 6, and also stores various data including contents such as images and audios forming web pages. Also, similarly to the storage unit 44 of the store terminal 4, the storage unit 62 stores a database (table) to control the number of items in stock of the products handled. This database has substantially the same content as the database stored in the storage unit 44.

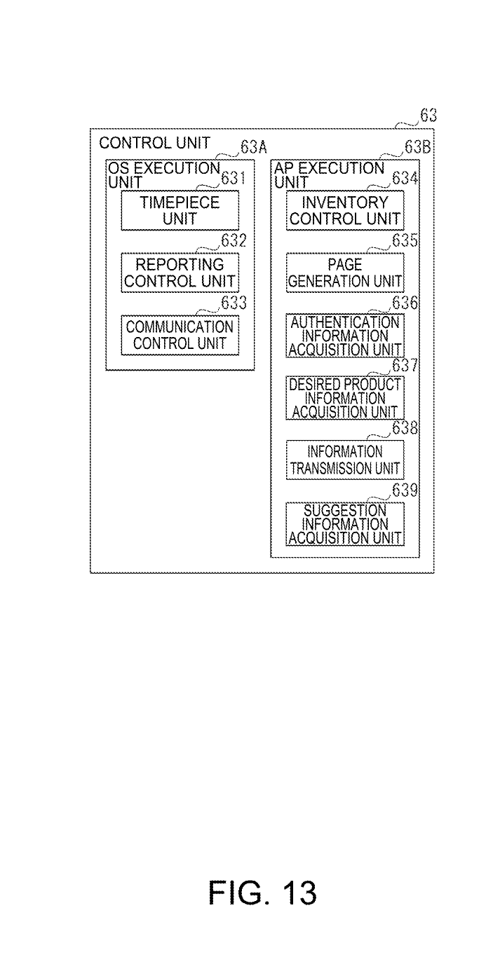

FIG. 13 is a block diagram showing the configuration of the control unit 63.

The control unit 63 is formed with a processing circuit such as a CPU which executes the programs stored in the storage unit 62, and controls the operation of the web server 6. When request information which requests a web page of the web store WS is received from a device (for example, the information processing device 3) via the communication unit 61, the control unit 63 transmits the web page to this device. Also, the control unit 63 periodically communicates with the management server 7 and transmits the content of the database to the management server 7.

The control unit 63 includes an OS execution unit 63A and AP execution unit 63B, as shown in FIG. 13.

The OS execution unit 63A is a functional unit which executes the OS stored in the storage unit 62, and has a timepiece unit 631, a reporting control unit 632, and a communication control unit 633, similarly to the OS execution unit 36A. These functional units 631 to 633 function similarly to the timepiece unit 361, the reporting control unit 362, and the communication control unit 363.

The AP execution unit 63B executes an application designated by the OS execution unit 63A, of the applications stored in the storage unit 62, similarly to the AP execution unit 46B. The AP execution unit 63B has an inventory control unit 634 which functions as the inventory control program is executed, a page generation unit 635 which functions as the page generation program is executed, and an authentication information acquisition unit 636, a desired product information acquisition unit 637, an information transmission unit 638, and a suggestion information acquisition unit 639 which function as the price acquisition program is executed.

The inventory control unit 634, similarly to the inventory control unit 464, controls the number of items in stock of the products handled at the web store WS, using the database stored in the storage unit 62. Also, the inventory control unit 634 periodically transmits the content of the database to the management server 7.

The page generation unit 635 generates a web page of the web store WS and transmits the web page to the device which transmits request information for requesting the web page, via the communication unit 61. Also, when the suggestion information is acquired by the suggestion information acquisition unit 639, described below, the page generation unit 635 generates and transmits a web page including this suggestion information.

The authentication information acquisition unit 636 acquires the authentication information of the intending buyer received from the device to which the web page is transmitted. This authentication information may be the user ID, as described above, or may be any other information which is authentication information stored in association with the user ID in the database held in the management server 7, described below, such as the store ST membership number, credit card number, login ID, and email address.

The desired product information acquisition unit 637 acquires the product information (product ID) of the desired product of the intending buyer, similarly received from the device to which the web page is transmitted.

The information transmission unit 638 transmits the authentication information of the intending buyer and the product information of the desired product thus acquired, to the management server 7 via the communication control unit 633 and the communication unit 61.

The suggestion information acquisition unit 639 acquires the suggestion information received from the management server 7 after the transmission of the information is carried out by the information transmission unit 638.

Here, the web server 6 transmits and receives information to and from the device operated by the intending buyer who wishes to purchase a product at the web store WS, for example, as follows.

At the web server 6, when request information for requesting a web page of the web store WS is received from the device, the page generation unit 635 generates and transmits, for example, a web page of a login screen.

As the authentication information is inputted at the device where the login screen is received, and the authentication information is received by the web server 6, the authentication information acquisition unit 636 acquires the authentication information. Then, the page generation unit 635 generates and transmits a web page of an introduction screen which introduces the products handled.

As an operation of putting a predetermined product (desired product) in a shopping cart at the device where the introduction screen is received, and the product information of the desired product is received by the web server 6, the desired product information acquisition unit 637 acquires the product information of the desired product.

Subsequently, the information transmission unit 638 transmits the authentication information of the intending buyer and the product information of the desired product thus acquired respectively, to the management server 7. The suggestion information acquisition unit 399 acquires the suggestion information from the management server 7. Then, the page generation unit 635, when transmitting the web page of the shopping cart, generates a web page where the suggested price included in the acquired suggestion information is set as the price of the desired product, and transmits this web page to the device.

After receiving operation information to carry out purchase processing (settlement processing) on the desired product from the device, the web server 6 executes this purchase processing.

By browsing the web page of the shopping cart displayed on the device in this way, the intending buyer can confirm the suggested price of the desired product before the purchase processing is executed.

### Configuration of Management Server

The management server 7 is equivalent to the price decision device according to the invention. The management server 7 is configured to be able to communicate with the information processing device 3, the store terminal 4, the vending machine 5 and the web server 6 via the network N, as shown in FIG. 1. The management server 7 stores the user information received from the information processing device 3.

The management server 7 also stores the content of the database for inventory control received from each of the store terminal 4, the vending machine 5 and the web server 6. That is, the management server 7 formed a POS system in collaboration with the store terminal 4, the vending machine 5 and the web server 6.

Moreover, the management server 7 executes price decision processing based on the authentication information of the intending buyer and the product information of the desired product received from the store terminal 4, the vending machine 5 and the web server 6, generates the suggestion information, and transmits the suggestion information to each of the store terminal 4, the vending machine 5 and the web server 6.

Also, the management server 7 transmits, to the information processing device 3, information about a product whose price changes according to the state of the user, of the products handled at the store ST and the vending machine 5 near the current position of the user using the detection device 2 and the information processing device 3 on the basis of the position information included in the user information.

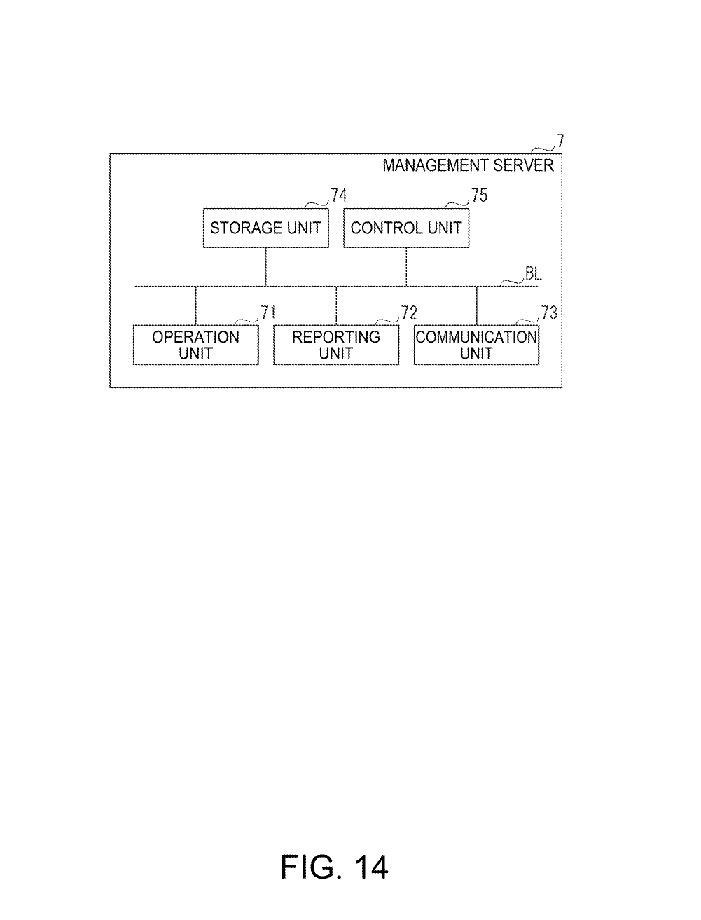

FIG. 14 is a block diagram showing the configuration of the management server 7.

The management server 7 has an operation unit 71, a reporting unit 72, a communication unit 73, a storage unit 74, and a control unit 75, as shown in FIG. 14. These units are connected to each other via a bus line BL.

The operation unit 71 is formed by an operation measure such as a keyboard and a pointing device and outputs an operation signal corresponding to an input operation by the user, to the control unit 75.

The reporting unit 72 has a display unit and audio output unit, similarly to the reporting unit 32, and outputs an image and audio corresponding to an image signal and audio signal inputted from the control unit 75.

The communication unit 73, under the control of the control unit 75, communicates with the information processing device 3, the store terminal 4, the vending machine 5 and the web server 6 via the network N.

The storage unit 74 stores various programs and data which are necessary for the operation of the management server 7. For example, the storage unit 74 stores a user information database, a store information database, a product information database, and a price decision database. Moreover, as the programs, the storage unit 74 stores an OS for controlling the management server 7, an update program for updating the store information database on the basis of the content of the database received from the product selling device PS (store terminal 4, vending machine 5 and web server 6), a price decision program for deciding the suggested price of the desired product, and a price-changing product transmission program for transmitting product information about a product whose price changes according to the state of the user, of the products handled at the store near the current position of the user.

Hereinafter, the databases stored in the storage unit 74 will be described in detail.

### User Information Database

The user information database includes a user information table and a user management table.

The user information table is a table in which the user information is set for each user ID allocated to each user. Specifically, in the user information table, the biometric information, the activity information, the attribute information, the medical bill information, the environment information and the purpose information, each included in the user information, are set as well as the user ID. The weather, the atmospheric temperature, the humidity and the WBGT included in the environment information are added by the management server 7, as described above.

In the user management table, the user ID and the authentication information corresponding to the user ID are set. Specifically, in the user management table, the user ID, and an authentication number such as the store ST point card number owned by the user indicated by the user ID, the web store WS membership number assigned to the user, the credit card number or the email address, are set in association with each other.

### Store Information Database

The store information database includes a handled product table and a store information table.

The handled product table is a table for controlling the number of items of the products handled at the store ST, the vending machine 5 and the web store WS. The content of the database for inventory control received from the product selling device PS is reflected on this table. Specifically, the handled product table is provided for each store ID assigned to each of the store ST, the vending machine 5 and the web store WS. In the handled product table, the product ID and the number of items of the product handled indicated by this product ID are set.

In the store information table, the store ID of each of the store ST and the vending machine 5, and information such as the address, contact details and business hours of the store ST and the vending machine 5, are set in association with each other. The store ID is allocated to the web WS as well.

### Product Information Database

The product information database includes a product information table and a detailed information table.

The product information table is a table in which the product ID (for example, JAN code) and information about the product are set. Specifically, in the product information table, the product ID, the product name, the explanation of the product, the retail price, the category or the like are set. Of these, in the category section, the categories of food, beverages, pharmaceuticals (including quasi drugs), miscellaneous goods and the like, are set.

The detailed information table is a table in which detailed information of each product is set and which is set for each of the categories. Specifically, the detailed information table includes a food information table, a beverages information table, a pharmaceuticals information table, and a miscellaneous goods table, or the like.

Of these, in the food information table and the beverages information table, the product ID, calories, product category, ingredients or substances contained (for example, vitamin K or the like) are set. Of these, as the product categories in the food information table, rice balls, noodles, bread, vegetables, processed food, dairy, meat and meat products, and dietary supplements or the like are set. Meanwhile, as the product categories in the beverages information table, the categories of tea beverages, coffee beverages, soft drinks, whey beverages, alcohol (refined sake, distilled liquor (shochu), wine, beer, or the like), and health drinks (pharmaceuticals including quasi drugs) or the like are set. In the pharmaceuticals information table, the product ID and the product category (the categories of cold remedies, gastrointestinal agents, analgesics or the like) are set. In the miscellaneous goods table, the product ID and the product category (the categories of clothes and sports shoes or the like) are set.

### Price Decision Database

The price decision database includes a plurality of change rate tables in which the rate of price change (coefficient of change) of a product according to the state of the user based on the user information is set for each product ID. In these change rate tables, the application condition, the product category, and the rate of price change are set, respectively.

Of these, the application condition is a configuration for applying the rate of price change set in the change rate table and is a condition for determining whether to apply the rate of price change or not, on the basis of the state of the user derived from the user information.

The product category is the category of the product to which the rate of price change is applied.

The rate of price change is equivalent to the price change information in the embodiment. This rate of price change is a rate of price change with respect to the retail price included in the product information and is expressed as a rate assuming the retail price as “1”. For example, if the rate of price change applied to a product is “0.95”, the retail price of the product multiplied by “0.95” is the suggested price suggested to the user.

The change rate table includes a purpose-specific change rate table which is selected and used according to the purpose information included in the user information, and a state-specific change rate table which is selected and used according to the state of the user derived by analyzing the user information.

### Purpose-Specific Change Rate Table

The purpose-specific change rate table can be, for example, a table for dieting which is selected if the purpose information is “maintenance of health (dieting)”, a table for improvement in athletic capability which is selected if the purpose information is “improvement in athletic capability”, and a table for rehabilitation which is selected if the purpose information is “rehabilitation”.

### Table for Dieting

As the application condition in the table for dieting, the relation between the calorie intake found on the basis of the meal information of the user information and the calories burned found on the basis of the biometric information and the activity information is set, an example of which is shown in Table 1 below. As the product category, “food and beverages” and “other” are set. As the rate of price change, rate of price changes corresponding to the respective application conditions and product categories are set.

TABLE 1

| Application Condition | Product Category | Rate of Price Change |
|---|---|---|
| Calorie intake > | Food and beverages | 1.00 |
| calories burned | Other | 0.99 |
| Calorie intake ≦ | Food and beverages | 1.00 |
| calories burned | Other | 0.95 |

In this way, for example, if the calorie intake of each user is below the calories burned, the suggested price of a product that is not food or beverages (product classified as “other”) is the retail price of this product multiplied by “0.95”.

Meanwhile, for example, if the calorie intake of each user is above the calories burned, the suggested price of a product that is not food or beverages is the retail price of this product multiplied by “0.99”.

Therefore, if the result of analysis shows that the purpose information indicating the purpose of using the health management application and the health management system 1 is “maintenance of health (dieting)” and that the calorie intake is below the calories burned, that is, if the user takes action conforming to the purpose of use, the discount rate for a predetermined product rises.

### Table for Improvement in Athletic Capability

As the application condition in the table for improvement in athletic capability, the exercise intensity and the duration of exercise included in the activity information of the user information are set, an example of which is shown in Table 2 below. As the product category, the product category of “bath additives, poultices, meat, sports shoes”, which are exercise-related products, is set. As the rate of price change, rate of price changes corresponding to the respective application conditions and product categories are set. The rate of price change applied to a product in a product category for which no rate of price change is set is “1.00” (that is, no change).

TABLE 2

| | | Product | Rate of Price |
|---|---|---|---|
| Application Condition | | Category | Change |
| Exercise | Duration of | Bath additives, | 0.90 |
| intensity | exercise | poultices, | |
| (% HRR) | 30 minutes or | meat, sports | |
| 60 or above | longer | shoes | |
| | Duration of | Bath additives, | 0.95 |
| | exercise | poultices, | |
| | Shorter than 30 | meat, sports | |
| | minutes | shoes | |
| Exercise | Duration of | Bath additives, | 0.95 |
| intensity | exercise | poultices, | |
| (% HRR) | 30 minutes or | meat, sports | |
| 40 or above, and | longer | shoes | |
| below 60 | | | |
| | Duration of | Bath additives, | 0.98 |
| | exercise | poultices, | |
| | Shorter than 30 | meat, sports | |
| | minutes | shoes | |
| Exercise | Duration of | All products | 1.00 |
| intensity | exercise | | |
| (% HRR) | — | | |
| Below 40 | | | |

In this way, for example, if the exercise intensity of the exercise carried out by the user on the day in question is 50% HRR and the duration of exercise is 20 minutes, the suggested price of a product classified into the product category of “bath additives, poultices, meat, sports shoes” is the retail price of the product multiplied by “0.98”.

If the exercise intensity of the exercise carried out by the user on the day in question is 60% HRR and the duration of exercise is 30 minutes or longer, the suggested price of a product classified into the product category of “bath additives, poultices, meat, sports shoes” is the retail price of the product multiplied by “0.90”.

Meanwhile, if the exercise intensity of the exercise carried out by the user on the day in question is below 40% HRR, the suggested prices of all products are the same as the retail prices thereof, regardless of the duration of exercise.

In this way, if the purpose information indicating the purpose of use of the health management application and the health management system 1 is “improvement in athletic capability” and the user carries out relatively high-intensity exercise for a long period of time, that is, if the user takes action conforming to the purpose of use, the discount rate for a predetermined product rises.

### Table for Rehabilitation

As the application condition in the table for rehabilitation, the purpose of rehabilitation included in the purpose information of the user information is set, an example of which is shown in Table 3 below. As the product category, product categories suitable and unsuitable for the purpose of rehabilitation are set. As the rate of price change, rate of price changes corresponding to the respective application conditions and product categories are set. As in the table for improvement in athletic capability, the rate of price change applied to a product in a product category for which no rate of price change is set is “1.00” (that is, no change).

TABLE 3

| | | Rate of Price |
|---|---|---|
| Application Condition | Product Category | Change |
| Purpose information = | Rice balls, noodles, bread | 1.03 |
| “improvement of | Vegetables | 0.95 |
| diabetes” | Dairy, beans and peas | 0.99 |
| Purpose information = | Fish products, brightly | 0.97 |
| “control of cerebral | colored vegetables, root | |
| infarction” | crops, dairy, green tea, | |
| | sesame | |
| | Foodstuffs containing | 2.00 |
| | vitamin K | |
| Purpose information = | Dietary supplements, | 0.97 |
| “rehabilitation from | vegetables, meat products | |
| bone fracture” | Alcohol | 1.05 |

In this way, if the purpose of rehabilitation is “improvement of diabetes”, the rate of price change for a product which is less likely to raise blood sugar levels is set to be lower. Therefore, the price of this product is discounted. Meanwhile, the price change for a product which is likely to raise blood sugar levels is set to be higher. Therefore, the price of this product includes a surcharge. Also, since the meal information includes the intakes of protein, fat, and carbohydrate, the rate of price change may be according to the balance (proportion) of these elements in a meal, meals on a day, or meals in a predetermined period.

If the purpose of rehabilitation is “control of cerebral infarction”, the rate of price change for a product which is considered to make cerebral infarction less likely to occur is set to be lower. Therefore, the price of this product is discounted. Meanwhile, the rate of price change for a product which is considered to make cerebral infarction likely to occur is set to be higher. Therefore, the price of this product includes a surcharge.

Similarly, if the purpose of rehabilitation is “rehabilitation from bone fracture”, the rate of price change for a product which is considered to help recovery from bone fracture is set to be lower. Therefore, the price of this product is discounted. Meanwhile, the rate of price change for a product which is considered to hamper recovery from bone fracture is set to be higher. Therefore, the price of this product includes a surcharge.

### State-Specific Change Rate Table

The state-specific change rate table is a change rate table selected and used according to the state of the user derived by analyzing the user information, as described above.

As the change rate table may include, for example, a table for mental state and a table for physical condition management applied according to the state of the user based on the biometric information, and a table for heatstroke applied according to the state of the user based on the biometric information and the environment information.

### Table for Mental State

The table for mental state is, for example, a table used in the case where a preset application condition is relevant when the user takes a rest after driving a car.

As the application conditions in the table for mental state, the desire for sleep and the stress indicator (for example, LF/HF level) derived from the biometric information of the user information are set, an example of which is shown in Table 4 below. As the product categories, “nutrition supplements, wakefulness-promoting foods” which are considered to reduce the desire for sleep, “confectioneries” which are considered to relax the under-stress state, and “all products”, are set. As the rate of price change, rate of price changes corresponding to the respective application conditions and product categories are set.

TABLE 4

| | | | Rate of Price |
|---|---|---|---|
| Application Condition | | Product Category | Change |
| Desire for | — | Nutrition supplements, | 0.95 |
| sleep: high | | wakefulness-promoting | |
| | | foods | |
| Desire for | Stress | Confectioneries | 0.97 |
| sleep: low | indicator: high | | |
| | Stress | All products | 0.95 |
| | indicator: low | | |

In this table for mental state, if the user's desire for sleep is high, the suggested price of any of the “nutrition supplements, wakefulness-promoting foods”, which are products considered to reduce the desire for sleep, is the retail price of the product multiplied by “0.95”, that is, a discount price, regardless of the under-stress state of the user.

If the user's desire for sleep is low but the stress indicator is high, the suggested price of any of the “confectioneries”, which are products considered to relax the under-stress state of the user, is the retail price of the produce multiplied by “0.97”, that is, a discount price.

If the user's desire for sleep is low and the stress indicator is low, it can be determined that the user is keeping a good state and therefore the suggested prices of all products are the retail prices of the products multiplied by “0.95”, that is, discount prices.

In this way, if the application conditions in the table for mental state are satisfied, the discount rate of a product which improves the mental state of the user rises.

### Table for Physical Condition Management

The table for physical condition management is a table constantly applied for the management of the physical condition of the user, for example, a table used in the case where a preset application condition is relevant when the user has a cold.

As the application conditions in the table for physical condition management, the body temperature and the stress indicator includes in the biometric information of the user information are set, an example of which is shown in Table 5 below. As the product categories, “cold remedies, hot drinks, nutrition supplements, dietary supplements, skin temperature cooling agents, tissue paper” which are considered to improve the state of the user or to be used frequently, and “alcohol” which is considered to deteriorate the state of the user, are set. As the rate of price change, rate of price changes corresponding to the respective application conditions and product categories are set.

TABLE 5

| | | | Rate of Price |
|---|---|---|---|
| Application Condition | | Product Category | Change |
| Body | Stress | Cold remedies, hot drinks, | 0.95 |
| temperature: | indicator: | nutrition supplements, | |
| 37° C. or | 2.2 or above | dietary supplements, skin | |
| above | | temperature cooling | |
| | | agents, tissue paper | |
| | | Alcohol | 1.10 |

In this table for physical condition management, if the body temperature of the user is 37° C. or above and the LF/HF level, which is the stress indicator, is 2.2 or above, it is determined that the user has a cold. Therefore, the suggested price of any of the above products considered to reduce the symptoms of cold is 95% of the retail price of the product, whereas the suggested price of “alcohol”, which is a product considered to deteriorate the symptoms of cold, is the retail price multiplied by “1.10”. If the body temperature of the user is not 37° C. or above, or the LF/HF level is not 2.2 or above, the rate of price changes set in the table for physical condition management are not applied.

In this way, if the application conditions in the table for physical condition management are satisfied, the price of a product which improves the physical condition of the user is discounted and the price of a product which deteriorates the physical condition includes a surcharge.

### Table for Heatstroke

The table for heatstroke is a table constantly applied for the management of the physical condition of the user, similarly to the table for physical condition management, for example, a table used in the case where a preset application condition is relevant when the user can suffer from heatstroke.

As the application conditions in the table for heatstroke, the atmospheric temperature and WBGT (Wet Bulb Globe Temperature) included in the environment information of the user information, and the amount of perspiration included in the biometric information, are set, an example of which is shown in Table 6 below. As the product categories, the category of “sports drinks, salt supplements”, which are heatstroke prevention products, is set. As the rate of price change, rate of price changes corresponding to the respective application conditions and product category are set.

TABLE 6

| | | | | Rate of |
|---|---|---|---|---|
| | | | Product | Price |
| Application Condition | | | Category | Change |
| Atmospheric | WBGT: | Amount of | Sports | 0.90 |
| temperature: | 31° C. or | perspiration: | drink, salt | |
| 35° C. or above | above | predetermined | supplements | |
| | | value or above | | |
| Atmospheric | WBGT: | Amount of | Sports | 0.95 |
| temperature: | 28° C. or | perspiration: | drink, salt | |
| 31° C. or | above, and | predetermined | supplements | |
| above, and | below 31° C. | value or above | | |
| below 35° C. | | | | |
| Atmospheric | WBGT: | Amount of | Sports | 0.95 |
| temperature: | 25° C. or | perspiration: | drink, salt | |
| 28° C. or | above, and | predetermined | supplements | |
| above, and | below 28° C. | value or above | | |
| below 31° C. | | | | |
| Atmospheric | WBGT: | Amount of | Sports | 0.97 |
| temperature: | 21° C. or | perspiration: | drink, salt | |
| 24° C. or | above, and | predetermined | supplements | |
| above, and | below 25° C. | value or above | | |
| below 28° C. | | | | |
| Atmospheric | WBGT: | Amount of | Sports | 1.00 |
| temperature: | below 21° C. | perspiration: | drink, salt | |
| below 24° C. | | — | supplements | |

Thus, for example, if the atmospheric temperature at the current position of the user is 35° C. or above, the WBGT is 31° C. or above, and the amount of perspiration of the user is predetermined value or above, it is determined that there is a high risk of heatstroke. Therefore, the suggested price of any of the above products which are considered to be effective in heatstroke prevention is the retail price of this product multiplied by “0.90”.

Meanwhile, for example, if the atmospheric temperature is below 24° C. and the WBGT is below 21° C., it is determined that the risk of heatstroke is low, regardless of the amount of perspiration of the user. Therefore, the suggested price of any of the above products which are considered to be effective in heatstroke prevention is the retail price of this product multiplied by “1.00”, that is, the retail price as it is.

In this way, if the application conditions in the table for heatstroke are satisfied, the price of a product which is considered to be effective in heatstroke prevention is discounted.

The price change tables described above are simply examples. The application conditions, the product categories and the rate of price changes in each table can be changed according to need.

### Configuration of Control Unit

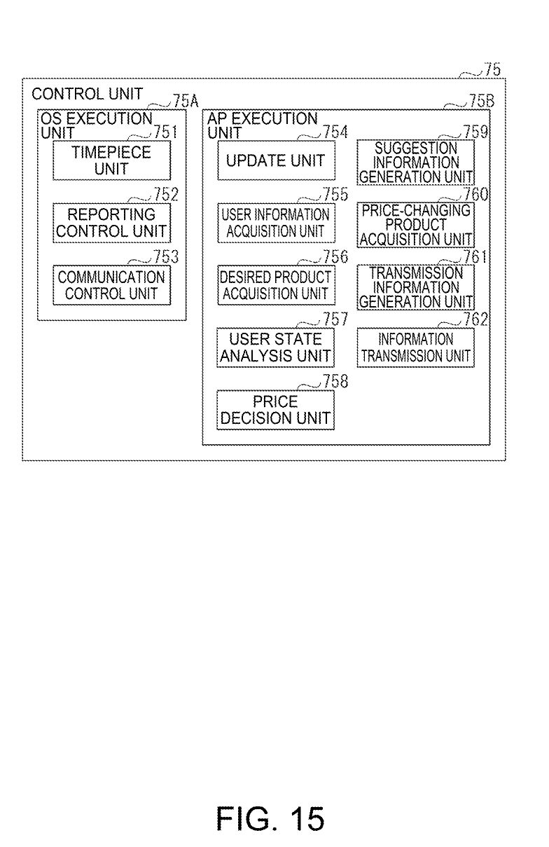

FIG. 15 is a block diagram showing the configuration of the control unit 75 of the management server 7.

The control unit 75 has a processing circuit such as a CPU and controls the operation of the management server 7. The control unit 75 has an OS execution unit 75A and an AP execution unit 75B, as shown in FIG. 15.

### Configuration of OS Execution Unit

The OS execution unit 75A is a functional unit which executes the OS. The OS execution unit 75A has a timepiece unit 751, a reporting control unit 752, and a communication control unit 753. These functional units 751 to 753 function similarly to the functional units 361 to 363.

### Configuration of AP Execution Unit

The AP execution unit 75B has, for example, an update unit 754, a user information acquisition unit 755, a desired product acquisition unit 756, a user state analysis unit 757, a price decision unit 758, a suggestion information generation unit 759, a price-changing product acquisition unit 760, a transmission information generation unit 761, and an information transmission unit 762, as functional units which function when various applications including the above programs are executed.

The update unit 754 functions when the AP execution unit 75B executes the update program, and the update unit 754 executes update processing to update the handled product table in the store information database. Specifically, the update unit 754 acquires the content of the database received with the store ID by the communication unit 73 from the store terminal 4, the vending machine 5 and the web server 6, and with the content of this database, updates the handled product table corresponding to the store ID in the store information database.

The user information acquisition unit 755 acquires the user information received from the information processing device 3 and registers the user information into the user information database. The user information acquisition unit 755 also registers information such as the biometric information, the activity information and the environment information received successively from the information processing device 3, in association with the corresponding user ID. Moreover, the user information acquisition unit 755 acquires the weather, atmospheric temperature, humidity and WBGT at the position of the user indicated by the position information from an external server (not shown) available for communication via the network N, on the basis of the position information included in the acquired environment information, and registers these pieces of information in association with the corresponding user ID. Also, the WBGT may be calculated by the user information acquisition unit 755 on the basis of the acquired atmospheric temperature and humidity or the like.

Also, the user information acquisition unit 755 functions when the price decision program is executed. When the authentication information of the intending buyer is received from the product selling device PS, the user information acquisition unit 755 acquires the user ID corresponding to the authentication information, referring the user database.

The desired product acquisition unit 756, the user state analysis unit 757, the price decision unit 758 and the suggestion information generation unit 759 function when the AP execution unit 75B executes the price decision program.

Of these, the desired product acquisition unit 756 acquires the product information (product ID) of the desired product received with the authentication information from the product selling device PS.

The user state analysis unit 757 analyzes the state of the user on the basis of the acquired user information. Specifically, the user state analysis unit 757 applies the user information to the purpose-specific change rate table corresponding to the purpose information included in the user information, and to the state-specific change rate table, of the rate of price change tables included in the price decision database, and thus acquires the state of the user. For example, the user state analysis unit 757 applies the user information to the table for physical condition management, and if it is determined that the application conditions in the table for physical condition management are satisfied, the user state analysis unit 757 analyzes the state of the user as a “state of having a cold”.

The price decision unit 758 decides the suggested price to be suggested to the user as the sales price of the desired product, on the basis of the user information corresponding to the acquired user ID, and the acquired product ID of the desired product.

Specifically, the price decision unit 758 first acquires the retail price of the desired product acquired by the desired product acquisition unit 756, referring to the product information table in the product information database.

The price decision unit 758 also applies the user information to the purpose-specific change rate table corresponding to the purpose information included in the user information, and to the state-specific change rate table, and acquires the rate of price change by which the retail price of the desired product is to be multiplied. As described above, if no rate of price change is set for the product of the corresponding product category, if the user ID corresponding to the acquired authentication information is not registered, and if there is no change rate table in which the application conditions are satisfied, the rate of price change is “1.00”.

The price decision unit 758 then decides the retail price of the desired product multiplied by the acquired rate of price change, as the suggested price of the desired product.

The suggestion information generation unit 759 generates suggestion information including the state of the user analyzed by the user state analysis unit 757 and the suggested price decided by the price decision unit 758. The suggestion information generation unit 759 may include the rate of price change acquired by the price decision unit 758, in the suggestion information. The suggestion information, thus generated, is transmitted by the information transmission unit 762, described below, to the product selling device PS from which the authentication information of the intending buyer and the product ID of the desired product are transmitted. The suggestion information is then suggested to the intending buyer (the user if this buyer has a user ID) by the product selling device PS.

### Price Decision Processing

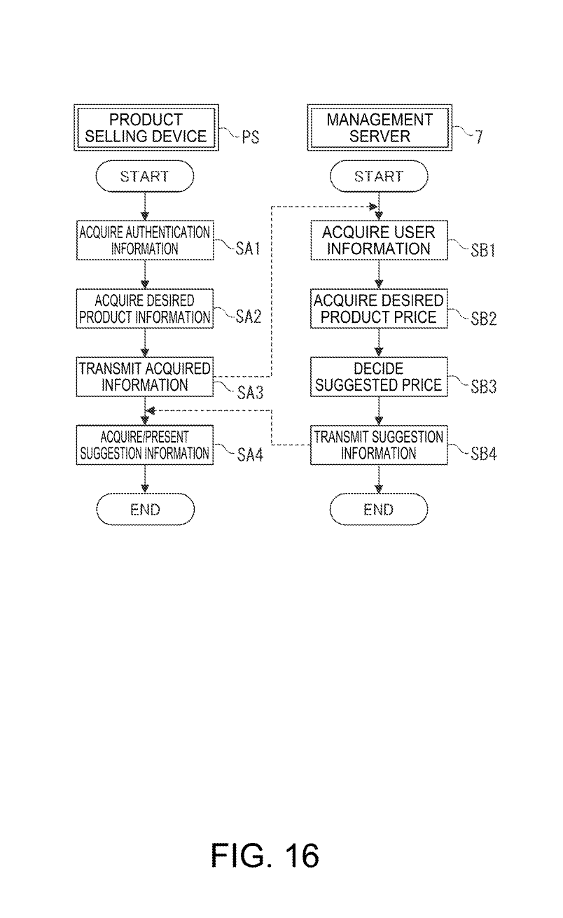

FIG. 16 is a flowchart showing the price decision processing executed by the product selling device PS (store terminal 4, vending machine 5 and web server 6) and the management server 7.

Here, as described above, if the intending buyer carries the desired product to the register at the store ST, if the intending buyer decides to purchase the desired product from the vending machine 5, and if the intending buyer puts the desired product in the shopping cart at the web store WS, the prices decision processing is executed by these product selling devices PS and the management server 7.

In this price decision processing, first, as shown in FIG. 16, the product selling device PS executes the price acquisition program and acquires the authentication information of the intending buyer and the product information (product ID) of the desired product (Steps SA1, SA2).

Then, the product selling device PS transmits the authentication information and the product information to the management server 7 (Step SA3) and shifts the processing to Step SA4.

At the management server 7, as the authentication information and the product information of the desired product are received, the user information acquisition unit 755 acquires the user ID corresponding to the authentication information and acquires the user information corresponding to the user ID (Step SB1).

Also, the desired product acquisition unit 756 acquires the retail price of the desired product on the basis of the acquired product information of the desired product (Step SB2).

Subsequently, the user state analysis unit 757 analyzes the state of the user on the basis of the acquired user information, and the price decision unit 758 acquires the rate of price change corresponding to the state of the user and the product category of the desired product and decides the suggested price, as described above (Step SB3).

Then, the suggestion information generation unit 759 generates suggestion information including the decided suggested price and transmits the suggestion information to the product selling device PS (Step SB4).

Thus, the price decision processing at the management server 7 is ended.

Meanwhile, the product selling device PS acquires the received suggestion information and presents the suggestion information to the intending buyer (the user if the buyer has a user ID) (Step SA4).

Thus, the price decision processing at the product selling device PS is ended.

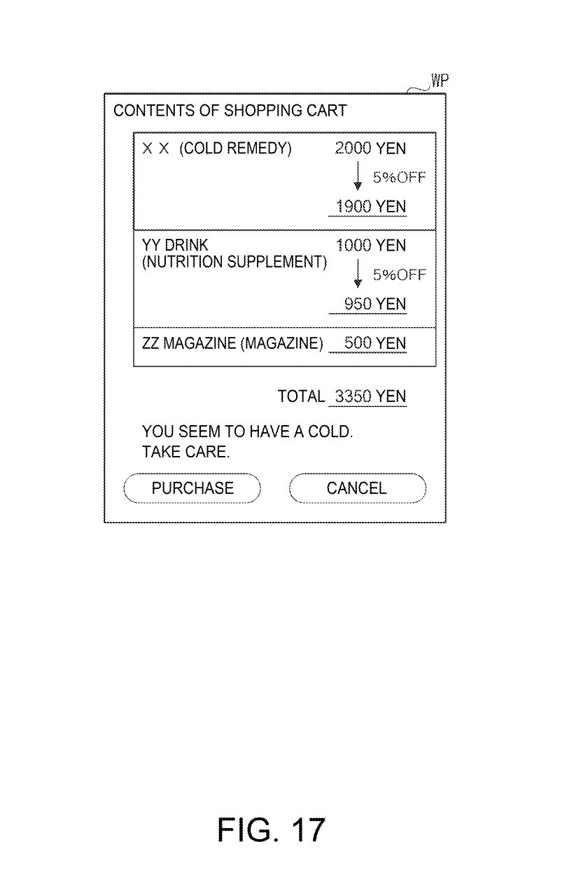

FIG. 17 shows an example of a suggestion screen WP. The suggestion screen WP is a screen of the web pages of the web store WS.

Based on the price decision processing, the store terminal 4 and the vending machine 5 cause the display units 421, 521 to display and present the acquired suggestion information to the user. Also, as described above, the web server 6 transmits a web page including the suggestion information to the information processing device 3 and causes the information processing device 3 to display the web page, thus presenting the suggestion information the user. For example, the web server 6 transmits a web page including the suggestion screen WP shown in FIG. 17 to the information processing device 3.

This suggestion screen WP includes the name and category of the desired product selected by the intending buyer, and the retail price of this desired product. If the intending buyer is the user having the user ID and the price changes according to the state of the user, the suggestion screen WP also includes the suggested price of the desired product and the discount rate (or surcharge rate) based on the rate of price change. In the suggestion screen WP shown in FIG. 17, a message corresponding to the analyzed state of the user is set. However, such a message may be omitted.

By viewing such a suggestion screen WP, the user is more likely to experience the advantages of using the health management application and the health management system 1 and therefore can be encouraged to continue using these.

Back to FIG. 15, the price-changing product acquisition unit 760 and the transmission information generation unit 761 function when the price-changing product transmission program is executed by the AP execution unit 75B.

When request information for requesting information about a product whose suggested price changes from the retail price according to the state of the user, and a user ID, are received from the information processing device 3, the price-changing product acquisition unit 760 acquires the product information (price-changing product information) of the price-changing product, which is the product whose suggested price changes, on the basis of the user information. In this case, the information processing device 3 may newly acquire position information from the information processing device 3 or the detection device 2 and transmit the latest position information with the request information and the user ID to the management server 7.

Specifically, as the request information and the user ID are received, the price-changing product acquisition unit 760 acquires the user information corresponding to this user ID, then searches for a store near the current position of the user corresponding to the user ID, from the store information table in the store information database on the basis of the received position information, and acquires the store ID.

Also, the price-changing product acquisition unit 760 acquires a product category whose price changes according to the current state of the user, that is, a product category whose rate of price change is not “1.00”, and this rate of price change, referring to the purpose-specific change rate table corresponding to the purpose information included in the user information and the state-specific change rate table.

Subsequently, from among the products handled at the store indicated by the acquired store ID, the price-changing product acquisition unit 760 acquires the product information of the product of the product category that is similarly acquired, referring to the handled product table and the product information table. In this case, the price-changing product acquisition unit 760 acquires, for example, the product ID, the product name and the retail price, as the product information.

Then, the price-changing product acquisition unit 760 multiplies the retail price of the acquired product information by the rate of price change and thus calculates the suggested price.

The price-changing product acquisition unit 760 thus acquires the product name, the retail price, the rate of price change and the suggested price of a product whose price changes according to the state of the user, that is, a product whose retail price and suggested price are different from among the products handled at a store (store ST or vending machine 5) near the current position of the user. The price-changing product acquisition unit 760 may acquire other information such as the description of the product, in addition to or instead of the above acquired information.

The transmission information generation unit 761 generates transmission information including the information acquired by the price-changing product acquisition unit 760.

The information transmission unit 762 is equivalent to the output unit according to the invention. The information transmission unit 762 transmits the suggestion information generated by the suggestion information generation unit 759, to the corresponding product selling device PS. The information transmission unit 762 also transmits the transmission information generated by the transmission information generation unit 761, to the information processing device 3. In this case, the information transmission unit 762 is equivalent to the price-changing product information acquisition unit according to the invention.

### Price-Changing Product Transmission Processing

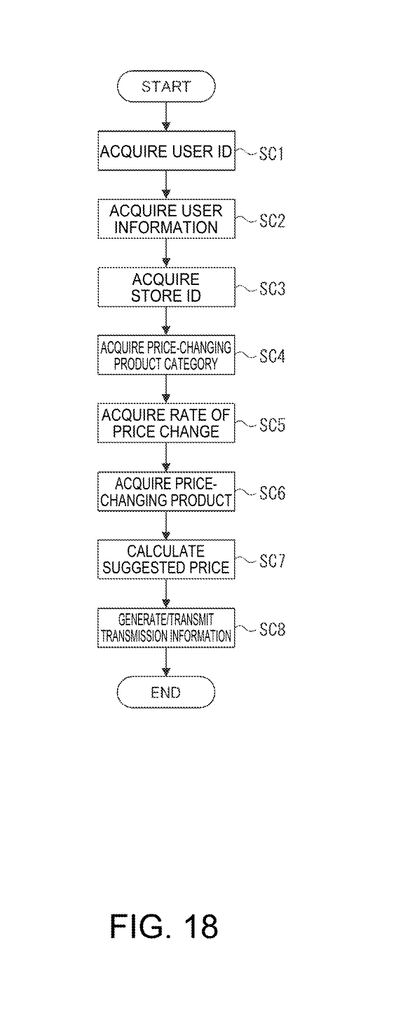

FIG. 18 is a flowchart showing price-changing product transmission processing.

When request information for requesting information about a product whose suggested price changes from the retail price according to the state of the user, and a user ID, are received from the information processing device 3, the management server 7 causes the price-changing product acquisition unit 760, the transmission information generation unit 761 and the information transmission unit 762 to executes the price-changing product transmission processing.

In the price-changing product transmission processing, as shown in FIG. 18, first, the price-changing product acquisition unit 760 acquires the received user ID (Step SC1) and acquires the user information corresponding to the user ID, from the user information table (Step SC2).

Then, the price-changing product acquisition unit 760 acquires the store information (store ID) of a store (store ST and vending machine 5) near the current position of the user, from the store information table in the store information database on the basis of the position information included in the acquired user information (or received position information) (Step SC3).

The price-changing product acquisition unit 760 also analyzes the state of the user on the basis of the acquired user information and acquires product category and the rate of price change of the product whose price changes according to the state of this user, referring to the purpose-specific change rate table and the state-specific change rate table (Steps SC4, SC5).

Subsequently, the price-changing product acquisition unit 760 acquires the product information of a price-changing product, which is a product of the acquired product category, of the products handled at the store indicated by the acquired store information (store ID) (Step SC6).

Next, the price-changing product acquisition unit 760 multiplies the retail price included in the acquired product information by the rate of price change of the corresponding product category and thus calculates the suggested price (Step SC7). The calculation processing for the suggested price is carries out for each product classified into the acquired product category.

Then, the transmission information generation unit 761 generates transmission information including the information acquired and calculated by the price-changing product acquisition unit 760, and the information transmission unit 762 transmits the transmission information to the information processing device 3 (Step SC8).

Thus, the price-changing product transmission processing is ended.

### Configuration of Price-Changing Product Display Screen

FIG. 19 shows an example of the price-changing product display screen DS.

The information processing device 3, receiving the transmission information, displays the price-changing product display screen DS shown in FIG. 19, for example.

This price-changing product display screen DS includes the name of the corresponding store (store ST or vending machine 5 present near the user) and also includes the name, product category and retail price of the price-changing product, the calculated suggested price of the price-changing product, and the discount rate (or surcharge rate) based on the rate of price change. By confirming such a price-changing product display screen DS, the user can confirm the information of a product whose price changes according to the state of the user, of the products handled at the store, before entering into the store or before purchasing the product at the store.

### Effects of Embodiments

The health management system 1 according to the above embodiment has the following effects.

The management server 7 decides a suggested price of a desired product of the user according to the state of the user based on the user information and transmits the suggested price to the product selling device PS. Thus, for example, if the desired product is a product which improves or maintains the statue of the user, the suggested price of the desired product can be lowered, whereas if the desired product is a product which deteriorates the state of the user, the suggested price of the desired product can be raised. This makes it easier to purchase the product which improves the state of the user, and harder to purchase the product which deteriorates the state. Therefore, the good state of the user can be maintained.

Since the management server 7 forms the health management system 1, it can allow the user to experience the financial advantage of purchasing the desired product which improves the state of the user. Therefore, the user can be encouraged to continue using the health management system 1.

The price decision unit 758 of the management server 7 decides the suggested price of the desired product on the basis of the retail price of the desired product and the rate of price change (price change information) of the desired product, acquired respectively from the database stored in the storage unit 74. This enables quick and proper decision of the suggested price of the desired product corresponding to the state of the user. Moreover, since the rate of price change can be specifically set for each state of the user, the suggested price corresponding to the current state of the user can be properly outputted, even with the same desired product.

The purpose-specific change rate table, which varies according to the purpose set by the user is stored, and the rate of price change for each product category is set in the purpose-specific change rate table in question. This enables decision of the suggested price of the desired product according to the state and purpose of the user. Therefore, the suggested price of the desired product can be decided properly.

If the rate of price change is acquired on the basis of the purpose-specific change rate table corresponding to the purpose set by the user, the state of the user is determined on the basis of an item acquired according to the purpose, from among a plurality of items included in the user information. Thus, the state of the user can be determined on proper information. Accordingly, not only the state of the user can be properly determined, but also the processing load on the management server 7 can be reduced compared with the case where the state of the user is determined on the basis of all the information included in the user information.

If the purpose set by the user is the maintenance of health, the state of the user is determined on the basis of the biometric information, the activity information, and the meal information of the user. Thus, the calorie intake can be calculated on the basis of the meal information, and the calories burned can be calculated on the basis of the biometric information and the activity information. If the calorie intake is above the calories burned and the desired product is a high-calorie food product, the suggested price of the desired product can be raised above the retail price, thus restraining further increase in calorie intake. Therefore, the purchase of a product suitable for the purpose can be promoted and the user can be guided to achieve the purpose.

If the purpose set by the user is the improvement in athletic capability, the state of the user is determined on the basis of the biometric information and the physical motion information of the user. Thus, the exercise intensity and the duration of exercise at the time of exercise of the user can be calculated on the basis of pulse waves and pulse rate included in the biometric information, and change in acceleration due to physical motion of the user included in the activity information. The degree of exercise carried out by the user can be grasped on the basis of the exercise intensity and the duration of exercise. Therefore, if the user carries out an exercise with relatively high intensity for a relatively long time, the suggested price of a product which contributes to improvement in athletic capability (product of a product category whose rate of price change is below 1 in the table for improvement in athletic capability) can be lowered, thus encouraging the purchase of a product suitable for the user's purpose, and encouraging further exercise. Thus, the use of the health management system 1 can be promoted further.

Here, as the information based on pulse waves, pulse waveform and pulse rate or the like may be employed as an example. Based on the pulse rate and the change in acceleration indicating the physical motion, the exercise intensity of the exercise carried out by the user and the calories burned by the user or the like can be calculated and estimated. Thus, as the biometric information included in the user information includes the information based on the pulse waves of the user, various states of the user can be grasped.

The information processing device 3 displays a web page (for example, the suggestion screen WP) including suggestion information transmitted and outputted from the management server 7, when executing purchase processing on the web pages of the web store WS generated by the web server 6. Similarly, the store terminal 4 and the vending machine 5 display the suggestion information. Thus, the user can securely grasp the suggested price of the user's own desired product.

The management server 7 transmits, to the information processing device 3, price-changing product information which is the product information of the price-changing product whose price changes according to the state of the user based on the user information, of the products handled at the store (store ST and vending machine 5) near the current position of the user indicated by the received position information. The information processing device 3 the price-changing product display screen DS including the price-changing product information. This enables the user to easily grasp the price-changing product handled at the store near the current position. Therefore, the user can grasp the price-changing product before visiting the store or before deciding to purchase the product at the store.

The price-changing product display screen DS, transmitted from the management server 7 and displayed by the information processing device 3, includes the suggested price of the price-changing product as well as the product information of the price-changing product. Thus, the user can grasp the suggested price (sales price) of the price-changing product before visiting the store or before deciding to purchase the product at the store. Therefore, the user's appetite to purchase a price-changing product with a lower suggested price than the retail price (for example, a product which improves the state of the user or a product suitable for the purpose) can be increased, and the appetite to purchase a price-changing product with a higher suggested price than the retail price (for example, a product which deteriorates the state of the user) can be reduced.

In the health management system 1, the detection device 2 detects biometric information and physical motion information of the user and transmits the biometric information and the physical motion information to the information processing device 3. Thus, the information processing device 3 and the management server 7 can determine the state of the user, using the biometric information and the physical motion information of the user that are actually detected. Therefore, the reliability of the determination on the state of the user can be improved and the time and effort of inputting the information can be saved, compared with the case where the user inputs the user's own biometric information and physical motion information. Moreover, since the detection device 2 is configured to transmit the detected biometric information and physical motion information to the information processing device 3 successively, the information processing device 3 and hence the management server 7 can determine the state of the user in real time.

### Modifications of Embodiment

The invention is not limited to the embodiment. Modifications, improvements and the like within a range that can achieve the object of the invention are included in the invention.

In the embodiment, the price (suggested price) of the desired product of the user is decided according to the state of the user based on the user information. However, this is not limiting. For example, membership points added according to the purchase of a product may be increased or decreased according to the state of the user.

In the embodiment, the rate of price change, which is a coefficient of change by which the retail price is multiplied, is described as the price change information. However, the invention is not limited to this example. For example, the price change information may be at least one of the discount rate and the surcharge rate, or may be the discount rate or surcharge rate that is set for each product.

In the embodiment, the management server 7 communicating with the information processing device 3, the store terminal 4, the vending machine 5 and the web server 6, functions as the price decision device according to the invention and decides the suggested price of a desired product on the basis of the user information received from the information processing device 3 and the authentication information and the product information (product ID) of the desired product received from the store terminal 4, the vending machine 5 and the web server 6. However, the invention is not limited to this example. For example, each of the store terminal 4, the vending machine 5 and the web server 6 may decide the suggested price (sales price) of the desired product according to the state of the user based on the user information. In this case, the product selling device PS communicating with the information processing device 3, of the store terminal 4, the vending machine 5 and the web server 6, may have the configuration (for example, the storage unit 74 and the control unit 75) and functions of the management server 7. Alternatively, the product selling device PS may configured to periodically acquire the retail price information from the management server 7 and may have the configuration of the control unit 75 (for example, the user state analysis unit 757 and the price decision unit 758) of the management server 7.

In the embodiment, the database is stored in the storage unit 74 of the management server 7, and this database is referred to when deciding the suggested price of a desired product. However, the invention is not limited to this example. For example, the suggested price of the desired product may be decided on the basis of a calculation formula corresponding to the state of the user.

The structure of each database and the structure of each table stored in the storage unit 74 are not limited to the above examples and can be altered according to need. Therefore, one or some of the items set in each table may be omitted, and other items may be added as well.

In the embodiment, the user information includes the purpose information, and the purpose-specific change rate table corresponding to the purpose indicated by the purpose information is stored in the storage unit 74. However, the invention is not limited to this example. That is, the purpose-specific change rate table may be omitted and the management server 7 may be configured to execute only the decision on the suggested price of the desired product based on the state-specific change rate table. Alternatively, the state-specific change rate table may be omitted and the management server 7 may be configured to execute only the decision on the suggested price of the desired product based on the purpose-specific change rate table.

In the embodiment, “maintenance of health (dieting)”, “improvement in athletic capability” and “rehabilitation” are employed as examples of the purposes set by the user. However, the invention is not limited to these examples. That is, other purposes can also be set.

If the purpose is “maintenance of health (dieting)”, the biometric information (pulse rate), the physical motion information (change in acceleration) and the meal information are referred to in order to calculate calorie intake and calories burned. However, this is not limiting. Other information may be referred to instead of or in addition to these pieces of information. The same applies to the case where the purpose is “improvement in athletic capability” and “rehabilitation”.

In the embodiment, the user information includes the biometric information and the physical motion information. However, the invention is not limited to this example. That is, the user information may not include the biometric information and the physical motion information. For example, the condition about the amount of perspiration included in the biometric information, which is set as an application condition in the table for heatstroke, may be omitted.

In the embodiment, the management server 7 executes the price-changing product transmission processing in response to a request from the information processing device 3 operated by the user, and causes the price-changing product display screen DS to be displayed by the information processing device 3. However, the invention is not limited to this example. That is, the price-changing product transmission processing may not be executed and the price-changing product display screen DS may not be displayed.

The price-changing product display screen DS includes the suggested price and discount rate (surcharge rate) of the product. However, this is not limiting. The price-changing product display screen DS only has to include information that can specify a product whose price changes according to the current state of the user. That is, the layout and content of the price-changing product display screen DS can be altered according to need. The same applies to the user information registration screen RS, the meal information registration screen MS and the suggestion screen WP as well.

In the embodiment, the detection device 2 which detects the biometric information and the physical motion information, and the information processing device 3, are configured as separate devices. However, the invention is not limited to this example. That is, the detection device 2 and the information processing device 3 may be integrated into one device.

In the embodiment, the information processing device 3 is formed by a mobile information terminal that can be carried by the user. However, this is not limiting and the information processing device 3 may be an information terminal which is relatively unsuitable for mobile use (for example, desktop PC) may be used. Also, for example, the information processing device 3 may be a terminal device which is installed in the store or various public institutions or the like, separately from the store terminal 4, and which can be connected to a device on the network N (management server 7 or the like). In this case, screens such as the price-changing product display screen DS may be displayed or a voucher including the price change information corresponding to the state and purpose of the user may be presented, for example, in response to the operation of this terminal device by the user. In this case, the price of the product which the user intends to purchase may be changed in response to the presentation of the voucher to product selling device PS by the user.

In the embodiment, the rate of price change is preset in each change rate table according to the state of the user based on the user information. Also, the rate of price change may be set according to the degree of achievement of purposes related to exercise, meals and the like that are set in advance by the user. For example, the rate of price change for a predetermined product category may be changed further according to the proportion of the actual calorie intake to a target calorie intake or the proportion of the amount of exercise actually done to a target amount of exercise.

In the embodiment, there is a product category where a rate of price change above “1.00” is set, in the change rate tables. However, this is not limiting and there may be no product category where a rate of price change above “1.00” is set. Alternatively, there may be no product category where a rate of price change below “1.00” is set.

In the embodiment, the receiving unit which receives and acquires the position information from position information satellites such as GPS is provided in the detection device 2. However, this is not limiting. The receiving unit may be provided in the information processing device 3.

The detection device 2 and the information processing device 3 have the analysis units 286, 366 which analyze the detected biometric information and physical motion information, and the management server 7 has the user state analysis unit 757. However, this is not limiting. The detection device 2 may not have the analysis unit 286, and the information processing device 3 may not have the analysis unit 366. That is, the user state analysis unit 757 may analyze the biometric information and the physical motion information. Also, one of the analysis units 286, 366 may be configured to analyze the biometric information and the physical motion information, and the management server 7 may be configured not to carry out the analysis processing of these pieces of information and to decide the suggested price of the desired product on the basis of the results of the analysis by the analysis unit.

In the embodiment, the information processing device 3 used by the user is a potable information terminal. However, this is not limiting and the information processing device 3 may be a stationary device.

In the embodiment, the management server 7 transmits, to the information processing device 3, the product information of a price-changing product whose price changes according to the state of the user, of the products handled at the store (store ST and vending machine 5) nearest to the current position of the user indicated by the position information. However, this is not limiting. The management server 7 may be configured to transmit the product information of a price-changing product, of the products handled at a store located within a predetermined range around the current position. As such stores, the vending machine 5 may be excluded.

In the embodiment, the management server 7 as the price decision device forms the POS system, together with the store terminal 4, the vending machine 5 and the web server 6, and also forms the health management system 1, together with the detection device 2 and the information processing device 3. However, this is not limiting. The functions of the management server 7 may also be applied to another system.

What is claimed is:

1. A price decision device comprising:
a user information acquisition unit which acquires user information about a user;
a desired product acquisition unit which acquires desired product information about a desired product of the user;
a price decision unit which decides a suggested price that is a price of the desired product suggested to the user according to a state of the user based on the user information that is acquired; and
an output unit which outputs the suggested price that is decided.

2. The price decision device according to claim 1, further comprising a storage unit which stores a retail price of a product and price change information of each of the product corresponding to the state of the user,
wherein the price decision unit decides the suggested price of the desired product on the basis of a retail price of the desired product and the price change information of the desired product corresponding to the state of the user that is acquired.

3. The price decision device according to claim 2, wherein
the user information includes purpose information indicating a purpose set by the user, and
the price change information varies according to the purpose information.

4. The price decision device according to claim 3, wherein
the state of the user is acquired on the basis of information acquired according to the purpose information, of a plurality of pieces of information included in the user information.

5. The price decision device according to claim 4, wherein
the user information includes each of biometric information, activity information, and meal information of the user, and
the state of the user is acquired on the basis of the biometric information, the activity information, and the meal information included in the user information, if the purpose is maintenance of health.

6. The price decision device according to claim 4, wherein
the user information includes each of biometric information and physical motion information of the user, and
the state of the user is acquired on the basis of each of the biometric information and the physical motion information if the purpose is improvement in athletic capability.

7. The price decision device according to claim 5, wherein
the biometric information of the user includes information based on pulse waves of the user.

8. A price decision system comprising:
an information processing device used by a user; and
the price decision device according to claim 1;
wherein the information processing device has a display unit which displays the suggested price outputted from the price decision device.

9. The price decision system according to claim 8, wherein
the information processing device comprises:
a processing device-side user information acquisition unit which acquires the user information; and
an information transmission unit which transmits the user information to the price decision device,
the user information includes position information indicating a current position of the user,
the price decision device comprises:
a price-changing product acquisition unit which acquires price-changing product information about a price-changing product that is a product with the suggested price changing according to the state of the user, of products handled by a store near the current position of the user, on the basis of the position information; and
a price-changing product information transmission unit which transmits the price-changing product information that is acquired, to the information processing device, and
the display unit displays the price-changing product information received from the price decision device.

10. The price decision system according to claim 9, wherein
the price-changing product acquisition unit decides a suggested price of the price-changing product according to the state of the user,
the price-changing product information transmission unit transmits the suggested price of the price-changing product to the information processing device, and
the display unit displays the price-changing product information and the suggested price of the price-changing product, each received from the price decision device.

11. The price decision system according to claim 8, further comprising a detection device which detects biometric information and physical motion information of the user included in the user information and which transmits the detected information to the information processing device.

12. A price decision method carried out by a price decision device which decides a price of a product, the method comprising:
acquiring user information about a user;
acquiring desired product information about a desired product of the user;
deciding a suggested price which is a price of the desired product suggested to the user, according to a state of the user based on the user information that is acquired; and
outputting the suggested price that is decided.
